(19) United States
(12) Patent Application Publication
(10) Pub. No.: US 2026/0049097 A1
(43) Pub. Date: Feb. 19, 2026

(54) LOW DIELECTRIC COMPOUND, MANUFACTURING METHOD THEREOF, RESIN COMPOSITION, AND ARTICLE MADE THEREFROM

(71) Applicant: ELITE ELECTRONIC MATERIAL (ZHONGSHAN) CO., LTD., Zhongshan City (CN)

(72) Inventors: Xinwen WANG, Zhongshan City (CN); Zhilong HU, Zhongshan (CN); Xiangnan LI, Zhongshan City (CN); Jianzhao LI, Zhongshan City (CN)

(73) Assignee: ELITE ELECTRONIC MATERIAL (ZHONGSHAN) CO., LTD., Zhongshan City (CN)

(21) Appl. No.: 18/952,881

(22) Filed: Nov. 19, 2024

(30) Foreign Application Priority Data
Aug. 14, 2024 (CN) 202411119709.3

(51) Int. Cl. C07F 9/6593; C08J 5/24; C08K 5/5399; C08L 71/12

(52) U.S. Cl. CPC C07F 9/65815; C08J 5/244; C08K 5/5399; C08L 71/126; C08L 2203/16; C08L 2203/20; C08L 2205/035

(57) ABSTRACT

The present disclosure provides a compound represented by Formula (I) and a manufacturing method thereof, a resin composition comprising the compound, and an article made from the resin composition. The resin composition comprises the compound represented by Formula (I), vinyl group-containing polyphenylene ether resin and vinyl-containing crosslinking agent. The article comprises a prepreg, a resin film, a laminate, a printed circuit board or a cured insulator that has improvements in one or more properties including glass transition temperature, dielectric constant, dissipation factor, thermal resistance after moisture absorption, flame retardancy, inner resin flow, and drop ball test.

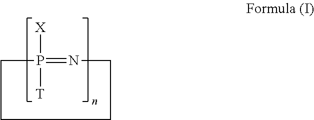

### CROSS-REFERENCE TO RELATED APPLICATIONS

This non-provisional application claims priority under 35 U.S.C. § 119(a) on Patent Application No(s). 202411119709.3 filed in China on Aug. 14, 2024, the entire contents of which are hereby incorporated by reference.

### BACKGROUND

### 1. Technical Field

The present disclosure relates to a compound, specifically a compound applicable to a prepreg, a resin film, a laminate, a printed circuit board or a cured insulator and a manufacturing method thereof, a resin composition comprising the same, and an article made therefrom.

### 2. Related Art

The speed and the capacity of the signals used in electronic devices such as mobile communication devices (mainly smartphones), network infrastructure equipment (e.g. base station equipment and servers), and large computers increase year by year. As a result, the printed circuit boards installed on these electronic devices must correspond to the integrity of signal transmission, requiring copper-clad laminate materials to have low dissipation factor. Due to the long-term operation of the equipment mentioned above, the heat resistance of copper-clad laminate materials is also required. In order to cope with the complex processing of printed circuit boards, the toughness of copper-clad laminates has drawn significant attention in the industry.

In addition, during the production of copper-clad laminates, the shelf life of the resin raw materials or the resin compositions thereof is often shortened due to the excessive reactivity of the resin raw materials. Therefore, developing stable resin raw materials and copper-clad laminate materials with excellent heat resistance, electrical properties and toughness has become an urgent problem to be solved.

### SUMMARY

In view of the above problems in the prior arts, specifically, the current material is unable to meet one or more of the technical demands, the main purpose of the present disclosure is to provide a compound and a manufacturing method thereof, a resin composition comprising the compound and an article made from the compound comprising a prepreg, a resin film, a laminate, a printed circuit board or a cured insulator to solve the above problems.

In one aspect, the present disclosure provides a compound having a structure represented by Formula (I):

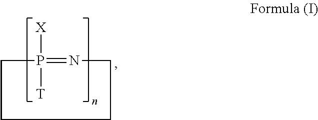

wherein in Formula (I), n is an integer of 3 to 6, X and T are the same or different, each of X and T is independently represented by Formula (1) or Formula (2), and at least one of X and T is represented by Formula (2), wherein m is an integer of 0 to 4, Rₐ is a hydrogen atom or an alkyl group with 1 to 4 carbon atoms, each of R_{b}, R_{c}, and R_{d} is independently an alkyl group with 1 to 4 carbon atoms, a phenyl group or a naphthyl group;

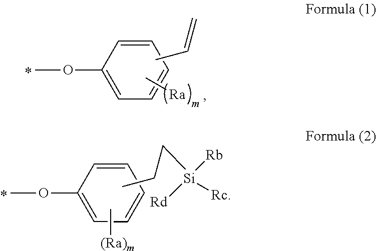

In the polyphenylene ether (PPO) system containing double bond resin, the compound of Formula (I) of the present disclosure can achieve one or more of effects of improving glass transition temperature, dielectric properties, heat resistance, inner resin flow or drop ball test at the same time.

In one aspect, the present disclosure provides a manufacturing method of the compound of Formula (I), comprising: a step of performing a hydrosilylation between a vinylphenoxy cyclophosphazene and a Si—H bond-containing silane compound.

In one aspect, the present disclosure provides a resin composition, comprising 80 parts by weight to 120 parts by weight of the compound of Formula (I), 100 parts by weight of a vinyl group-containing polyphenylene ether resin, and 15 parts by weight to 45 parts by weight of a vinyl group-containing crosslinking agent.

In one aspect, the present disclosure further provides an article made from the resin composition, comprising a prepreg, a resin film, a laminate, a printed circuit board or a cured insulator.

The resin composition or the article made therefrom provided by the present disclosure may have improvements in one or more of the following properties: glass transition temperature, dielectric constant, dissipation factor, thermal resistance after moisture absorption, flame retardancy, inner resin flow, and drop ball test.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a FTIR spectrum of a raw material dimethylphenylsilane, a raw material hexakis(4-vinylphenoxy)cyclotriphosphazene and a product compound B.

FIG. 2 is a ¹H NMR spectrum of the raw material dimethylphenylsilane, the raw material hexakis(4-vinylphenoxy)cyclotriphosphazene and the product compound B.

FIG. 3 is a HPLC curve of the product compound B.

### DETAILED DESCRIPTION

All technical and scientific terms used herein have the common meaning as understood by those skilled in the art. If otherwise specified, the terms defined herein shall prevail.

The term “comprises,” “comprising,” “includes,” “including,” “has,” “having” belongs to an open-ended transitional phrase (i.e., other elements not listed herein may be contained). The terms “consisting of,” “composed by,” “remainder being,” or the like belongs to close-ended transitional phrases.

Numerical ranges used herein shall be understood as including all of the possible subranges and individual numerals or values therein (including fractions and integers).

The value used herein includes all of the values which will be the same as such value after being rounded off.

It should be understood that members in the Markush group can individually or combinely be used to describe the present disclosure. As used herein, “or a combination thereof” means “or any combination thereof”.

The phrase “a composition comprises A, B, and C, wherein A comprises a1, a2, or a3” has the same meaning as the phrase “a composition comprises A, B, and C, wherein A comprises a1, a2, a3, or a combination thereof”, that is, “a composition comprises A, B, and C, wherein A comprises a1, a2, a3, a combination of a1 and a2, a combination of a1 and a3, a combination of a2 and a3, or a combination of a1, a2, and a3.”.

The “isomer” refers to a compound having the same molecular formula but differing in the nature or order of bonding of its atoms or the arrangement of its atoms in space.

In the structural formulas herein, a symbol “*” indicates the bonding site.

The “resin” may include monomers, polymers thereof, combinations of monomers, combinations of polymers thereof, or combinations of monomers and polymers thereof, but the present disclosure is not limited thereto. For instance, “maleimide resin” in the present disclosure includes a maleimide monomer (a maleimide small molecule compound), a maleimide polymer, a combination of maleimide monomers, a combination of maleimide polymers, or a combination of maleimide monomer(s) and maleimide polymer(s).

A polymer refers to the product formed by monomer(s) via polymerization A polymer may include a homopolymer (autopolymer), a copolymer, a prepolymer, etc., but the present disclosure is not limited thereto.

A homopolymer refers to a chemical substance formed by a single compound via polymerization, addition polymerization or condensation polymerization. A copolymer refers to a chemical substance formed by two or more compounds via polymerization, addition polymerization or condensation polymerization and comprises: random copolymers, such as a structure of -AABABBBAAABBA-; alternating copolymers, such as a structure of -ABABABAB-; graft copolymers, such as a structure of -AA(A-BBBB)AA(A-BBBB)AAA-; and block copolymers, such as a structure of -AAAAA-BBBBBB-AAAAA-. A prepolymer refers to a polymer having a lower molecular weight between the molecular weight of monomer and the molecular weight of final polymer, and a prepolymer contains a reactive functional group capable of participating further polymerization to obtain the final polymer product which has been fully crosslinked or cured.

The “polymer” includes an oligomer, but the present disclosure is not limited thereto. Oligomer refers to a polymer with 2 to 20, typically 2 to 5, repeating units.

A modification comprises a product derived from a resin with its reactive functional group modified, a product derived from a prepolymerization reaction of a resin and other resins, a product derived from a crosslinking reaction of a resin and other resins, a product derived from homopolymerizing a resin, a product derived from copolymerizing a resin and other resins, etc. For instance, a modification may refer to replacing a hydroxyl group with a vinyl group via a chemical reaction, or obtaining a terminal hydroxyl group from a chemical reaction of a terminal vinyl group and p-aminophenol, but the present disclosure is not limited thereto.

An alkyl group, an alkenyl group and a hydrocarbyl group described herein comprise various isomers thereof. For instance, a propyl group comprises n-propyl and isopropyl.

The “vinyl group-containing” in the present disclosure comprises functional groups with an ethylene carbon-carbon (C═C) bond or its derivatives in a compound structure. Thus, the example of “vinyl group-containing” may comprise containing a functional group, such as vinyl group, allyl group, vinyl benzyl group and methacrylate group in a structure, but the present disclosure is not limited thereto. The location of the functional group is not specified, for instance, the functional group may be located at the terminal of a long-chain structure. Thus, for instance, a vinyl group-containing polyphenylene ether resin may be a polyphenylene ether resin containing a functional group, such as vinyl group, allyl group, vinyl benzyl group and methacrylate group, but the present disclosure is not limited thereto.

The unsaturated bond described herein refers to a reactive unsaturated bond, such as an unsaturated double bond with the potential of being crosslinked with other functional groups, such as an unsaturated carbon-carbon double bond with the potential of being crosslinked with other functional groups, but the present disclosure is not limited thereto.

Part(s) by weight represents weight part(s) in any weight unit, such as kilogram, gram, pound and so on, but the present disclosure is not limited thereto. For instance, 100 parts by weight of a vinyl group-containing polyphenylene ether resin may represent 100 kilograms of the vinyl group-containing polyphenylene ether resin or 100 pounds of the vinyl group-containing polyphenylene ether resin.

### Compound:

In one exemplary embodiment, the compound of the present disclosure has a structure represented by Formula (I):

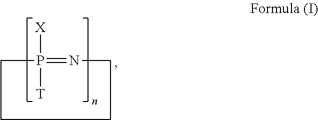

wherein in Formula (I), n is an integer of 3 to 6, X and T are the same or different, each of X and T is independently represented by Formula (1) or Formula (2), and at least one of X and T is represented by Formula (2), wherein m is an integer of 0 to 4, Rₐ is a hydrogen atom or an alkyl group with 1 to 4 carbon atoms, each of R_{b}, R_{c} and R_{d} is independently an alkyl group with 1 to 4 carbon atoms, a phenyl group or a naphthyl group;

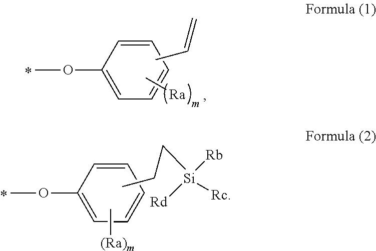

The compound of Formula (I) herein includes various isomers.

In one exemplary embodiment, structures of X and T in Formula (I) are represented by Formula (3) or Formula (4):

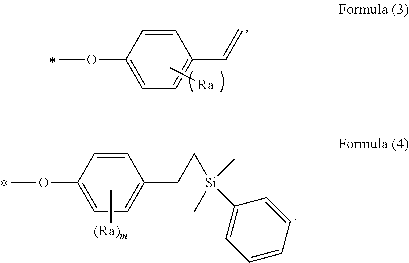

In one exemplary embodiment, the structures of X and T in Formula (I) comprise at least two Formula (3), and the structures of X and T in Formula (I) comprise at least two Formula (4).

For instance, when n is 3, the structure of X and T in Formula (I) are respectively represented by Formula (3) and Formula (4), and the number of Formula (3) is 2, 3 or 4, the number of Formula (4) is 4, 3 or 2;
when n is 4, the structure of X and T in Formula (I) are respectively represented by Formula (3) and Formula (4), and the number of Formula (3) is 2, 3, 4, 5 or 6, the number of Formula (4) is 6, 5, 4, 3 or 2;
when n is 5, the structure of X and T in Formula (I) are respectively represented by Formula (3) and Formula (4), and the number of Formula (3) is 2, 3, 4, 5, 6, 7 or 8, the number of Formula (4) is 8, 7, 6, 5, 4, 3 or 2;
when n is 6, the structure of X and T in Formula (I) are respectively represented by Formula (3) and Formula (4), and the number of Formula (3) is 2, 3, 4, 5, 6, 7, 8, 9 or 10, the number of Formula (4) is 10, 9, 8, 7, 6, 5, 4, 3 or 2.

In the structure of the compound of Formula (I) of the present disclosure, the phosphazene ring formed by phosphorus atoms and nitrogen atoms has a property of flame retardancy, and the presence of the silicon atom can achieve a synergistic flame retardant effect, facilitate the dehydration and carbonization of the polymer during thermal cracking, and form a Si—C carbonaceous protective layer, thereby facilitating a good flame retardancy of the material. Therefore, the compound of Formula (I) has a better flame retardancy.

For instance, the compound of Formula (I) has at least two reactive vinyl groups capable of participating in a reaction, and can be used as a crosslinking agent. For instance, in a system containing double bond resin such as BMI or polyphenylene ether (PPO), the compound of Formula (I) can provide a better flame retardancy, compared to divinylbenzene (DVB), triallyl isocyanurate (TAIC) or other conventional crosslinking agents.

For instance, in the polyphenylene ether (PPO) system containing double bond resin, the compound of Formula (I) can achieve one or more of effects of improving glass transition temperature, dielectric properties, heat resistance, inner resin flow or drop ball test at the same time.

For instance, in order to ensure both reactivity and dielectric properties, the compound of Formula (I) preferably has following structures.

In one exemplary embodiment, when n is 3, the compound of Formula (I) has a structure represented by Formula (II), Formula (III) or Formula (IV):

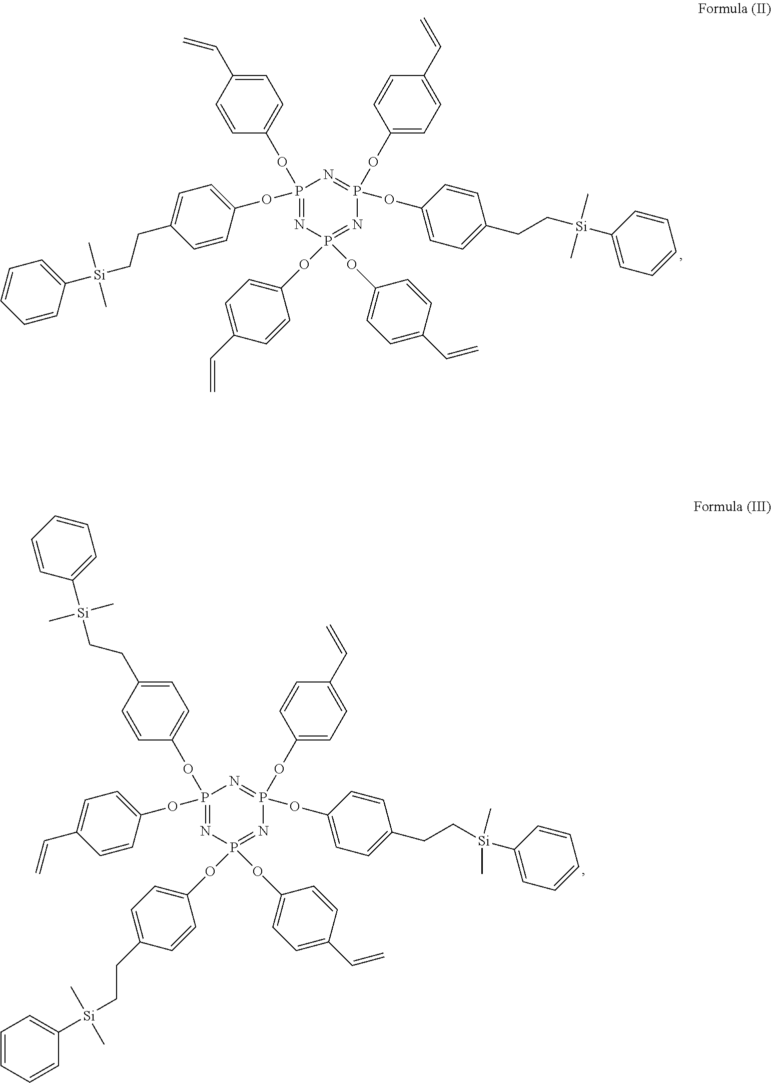 [SMILES: C=Cc1ccc(OP2(Oc3ccc(C=C)cc3)=NP(Oc3ccc(C=C)cc3)(Oc3ccc(CC[Si](C)(C)c4ccccc4)cc3)=NP(Oc3ccc(C=C)cc3)(Oc3ccc(CC[Si](C)(C)c4ccccc4)cc3)=N2)cc1 ; C=Cc1ccc(OP2(Oc3ccc(CC[Si](C)(C)c4ccccc4)cc3)=NP(Oc3ccc(C=C)cc3)(Oc3ccc(CC[Si](C)(C)c4ccccc4)cc3)=NP(Oc3ccc(C=C)cc3)(Oc3ccc(CC[Si](C)(C)c4ccccc4)cc3)=N2)cc1]

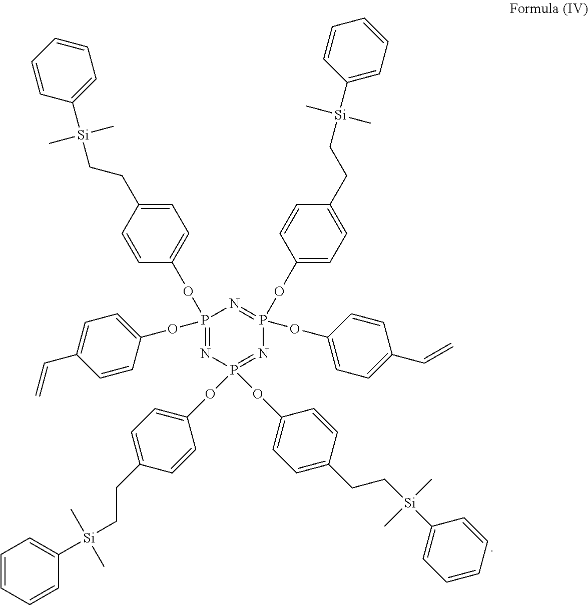 [SMILES: C=Cc1ccc(OP2(Oc3ccc(CC[Si](C)(C)c4ccccc4)cc3)=NP(Oc3ccc(C=C)cc3)(Oc3ccc(CC[Si](C)(C)c4ccccc4)cc3)=NP(Oc3ccc(CC[Si](C)(C)c4ccccc4)cc3)(Oc3ccc(CC[Si](C)(C)c4ccccc4)cc3)=N2)cc1]

In one exemplary embodiment, when n is 4, the compound of Formula (I) has a structure represented by Formula (V):

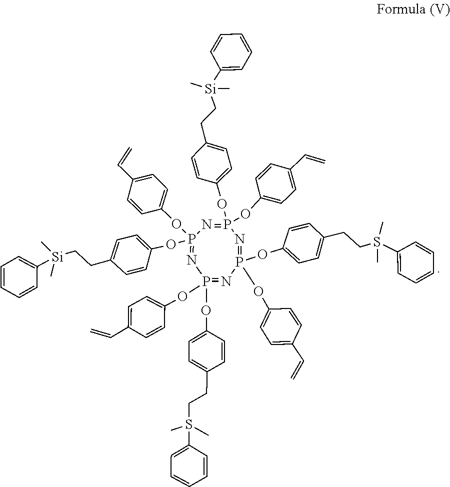

In one exemplary embodiment, when n is 5, the compound of Formula (I) has a structure represented by Formula (VI):

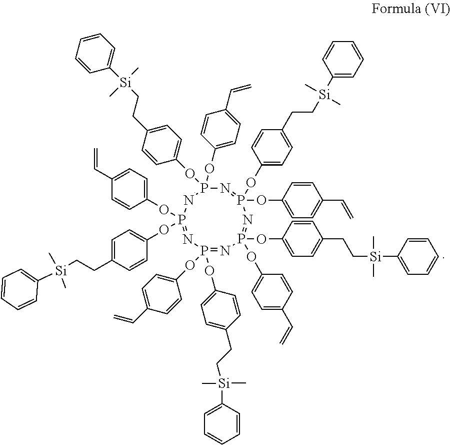 [SMILES: C=Cc1ccc(OP2(Oc3ccc(CC[Si](C)(C)c4ccccc4)cc3)=NP(Oc3ccc(C=C)cc3)(Oc3ccc(CC[Si](C)(C)c4ccccc4)cc3)=NP(Oc3ccc(C=C)cc3)(Oc3ccc(CC[Si](C)(C)c4ccccc4)cc3)=NP(Oc3ccc(C=C)cc3)(Oc3ccc(CC[Si](C)(C)c4ccccc4)cc3)=NP(Oc3ccc(C=C)cc3)(Oc3ccc(CC[Si](C)(C)c4ccccc4)cc3)=N2)cc1]

In one exemplary embodiment, when n is 6, the compound of Formula (I) has a structure represented by Formula (VII):

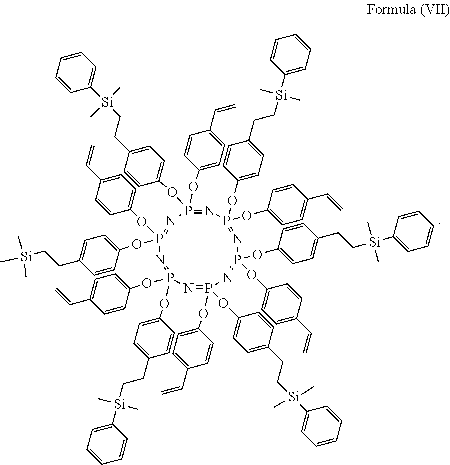 [SMILES: C=Cc1ccc(OP2(Oc3ccc(CC[Si](C)(C)C)cc3)=NP(Oc3ccc(C=C)cc3)(Oc3ccc(CC[Si](C)(C)c4ccccc4)cc3)=NP(Oc3ccc(C=C)cc3)(Oc3ccc(CC[Si](C)(C)c4ccccc4)cc3)=NP(Oc3ccc(C=C)cc3)(Oc3ccc(CC[Si](C)(C)c4ccccc4)cc3)=NP(Oc3ccc(C=C)cc3)(Oc3ccc(CC[Si](C)(C)c4ccccc4)cc3)=NP(Oc3ccc(C=C)cc3)(Oc3ccc(CC[Si](C)(C)c4ccccc4)cc3)=N2)cc1]

### Manufacturing Method of the Compounds

In one exemplary embodiment, the present disclosure provides a manufacturing method of the compound of Formula (I), mainly comprising a step of performing a hydrosilylation between a vinylphenoxy cyclophosphazene and a Si—H bond-containing silane compound.

For instance, under a nitrogen atmosphere, the vinylphenoxy cyclophosphazene and the Si—H bond-containing silane compound may be subjected to a hydrosilylation by heating and refluxing in a solvent in the presence of a catalyst.

In one exemplary embodiment, the catalyst may be a catalyst which can react the vinylphenoxy cyclophosphazene with the Si—H bond-containing silane compound, such as bis(1,3-divinyl-1,1,3,3-tetramethyldisiloxane) platinum (also known as Karstedt catalyst). The catalyst may be added in a conventional manner, such as dropwise addition or pouring. The duration of adding the catalyst may be between 1 hour and 6 hours, such as between 1 hour and 5 hours, or such as between 1 hour and 4 hours. The amount of the catalyst is not particularly limited, as long as it can catalyze the reaction, for instance, it may be between 2 ppm and 30 ppm, or may be between 3 ppm and 20 ppm.

In one exemplary embodiment, the heating temperature of the reaction may be between 5° C. and 100° C., such as between 10° C. and 90° C., or between 20° C. and 80° C., such as 30° C., 40° C., 50° C., 60° C. or 70° C.

In one exemplary embodiment, the reflux time of the reaction may be between 1 hour and 12 hours, such as between 1 hour and 11 hours, or between 1 hour and 10 hours.

In one exemplary embodiment, a suitable solvent includes benzene, toluene (TL), xylene, dimethylacetamide (DMAC), dimethylformamide (DMF), 2-propanol methyl ether (PM), propylene glycol methyl ether acetate (PMA), cyclohexanone (CYC), acetone, butanone (MEK) or a combination thereof, but the present disclosure is not limited thereto. The amount of the solvent is not limited, and may be between 200 mL and 1500 mL, such as between 300 mL and 1300 mL, or between 400 mL and 1200 mL.

In one exemplary embodiment, after the reaction, the initial product may be further washed with an alcohol solvent (such as methanol, but the present disclosure is not limited thereto) as needed so as to remove by-products and impurities in the reaction, thereby improving the purity of the obtained compound.

The amounts of both of the vinylphenoxy cyclophosphazene and the Si—H bond-containing silane compound are not particularly limited. In one exemplary embodiment, when n of the compound of Formula (I) is an integer of 3 to 6, the molar ratio of the vinylphenoxy cyclophosphazene to the Si—H bond-containing silane compound is between 1:1 and 1:2n, preferably, between 1:2 and 1:(2n-2), more preferably 1:n.

As one of the reactants, the vinylphenoxy cyclophosphazene may have a structure of Formula (A) below, wherein n is an integer of 3 to 6, m is an integer of 0 to 4, and Rₐ is a hydrogen atom or an alkyl group with 1 to 4 carbon atoms;

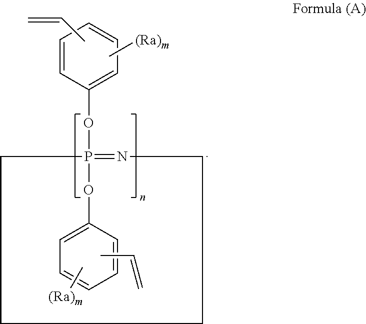

For instance, the vinylphenoxy cyclophosphazene is a hexakis(vinylphenoxy)cyclotriphosphazene, an octakis(vinylphenoxy)cyclotetraphosphazene, a decakis(vinylphenoxy)cyclopentaphosphazene or a dodecakis(vinylphenoxy)cyclohexaphosphazene.

In one exemplary embodiment, the vinylphenoxy cyclophosphazene is preferably a vinylphenoxy cyclophosphazene where a vinyl group is located at a para position.

As one of the reactants, the Si—H bond-containing silane compound may have a structure of Formula (B) below:

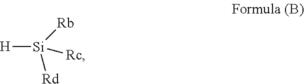

wherein, R_{b}, R_{c}, and R_{d} are independently selected from an alkyl group with 1 to 4 carbon atoms, a phenyl group or a naphthyl group. For instance, the Si—H bond-containing silane compound comprises a triethylsilane, a triisopropylsilane, a triisobutylsilane, a triphenylsilane, a methyldiphenylsilane, a tert-butyldiphenylsilane, a tert-butyldimethylsilane, a dimethylphenylsilane, a dimethylnaphthylsilane or a combination thereof.

### Synthesis and Qualitative Analysis of the Compounds

### Synthesis Example 1: Preparation of Compound A

A thermometer and a condenser are inserted into a three-necked flask, and about 500 mL of toluene, 1 mole (about 849 g) of hexakis(4-vinylphenoxy)cyclotriphosphazene, 2 moles (about 272 g) of dimethylphenylsilane are added thereto. Under a nitrogen atmosphere, the solution is heated to 60° C., and 10 ppm of a Karstedt catalyst is slowly added dropwise into the three-necked flask within 2 hours. The reaction is refluxed for 8 hours, and the solution is cooled to room temperature after the reaction is completed, thereby obtaining compound A (having a structure represented by Formula (II)).

The solution is then fully washed with methanol, and the lower transparent liquid of the solution is separated and retained in a separatory funnel. The lower transparent liquid is then placed in a vacuum dryer and dried at room temperature for 12 hours to obtain a purified viscous liquid. The yield of compound A is about 85.0%.

### Synthesis Example 2: Preparation of Compound B

With reference to the preparation method of Synthesis Example 1, the amount of toluene is adjusted to 550 mL, the amount of dimethylphenylsilane is adjusted to 3 moles (about 408 g), and the other steps are the same, thereby obtaining compound B (having a structure represented by Formula (III)), and a viscous liquid with purity of more than 95% may be obtained by using the purification method of Synthesis Example 1, and the yield of compound B is about 95.5%.

### Synthesis Example 3: Preparation of Compound C

With reference to the preparation method of compound A, the amount of toluene is adjusted to 600 mL, the amount of dimethylphenylsilane is adjusted to 4 moles (about 544 g), and the other steps are the same, thereby obtaining compound C (having a structure represented by Formula (IV)), and the yield of compound C is about 92.0% after purified by the purification method of Synthesis Example 1.

### Synthesis Example 4: Preparation of Compound D

With reference to the preparation method of compound A, the amount of toluene is adjusted to 750 mL, the 1 mole of hexakis(4-vinylphenoxy)cyclotriphosphazene is changed into 1 mole (about 1132 g) of octakis(4-vinylphenoxy)cyclotetraphosphazene, the amount of dimethylphenylsilane is adjusted to 4 moles (about 544 g), and the other steps are the same, thereby obtaining compound D (having a structure represented by Formula (V)), and the yield of compound D is about 88.0% after purified by the purification method of Synthesis Example 1.

### Synthesis Example 5: Preparation of Compound E

With reference to the preparation method of compound A, the amount of toluene is adjusted to 900 mL, the 1 mole of hexakis(4-vinylphenoxy)cyclotriphosphazene is changed into 1 mole (about 1415 g) of decakis(4-vinylphenoxy)cyclopentaphosphazene, the amount of dimethylphenylsilane is adjusted to 5 moles (about 680 g), and the other steps are the same, thereby obtaining compound E (having a structure represented by Formula (VI)), and the yield of compound E is about 92.0% after purified by the purification method of Synthesis Example 1.

### Synthesis Example 6: Preparation of Compound F

With reference to the preparation method of compound A, the amount of toluene is adjusted to 1100 mL, the 1 mole of hexakis(4-vinylphenoxy)cyclotriphosphazene is changed into 1 mole (about 1698 g) of dodecakis(4-vinylphenoxy)cyclohexaphosphazene, the amount of dimethylphenylsilane is adjusted to 6 moles (about 816 g), and the other steps are the same, thereby obtaining compound F (having a structure represented by Formula (VII)), and the yield of compound F is about 90.0% after purified by the purification method of Synthesis Example 1.

### Comparative Synthesis Example 1: Preparation of Compound 1

First, 40.2 g (0.3 mole) of 4-allylphenol is added to a three-necked flask provided with mechanical stirring and nitrogen, 250 mL of dioxane is added and stirred to dissolve, and then 0.26 g of tetrabutylammonium bromide is added and stirred at room temperature for 30 minutes. Then, 11.73 g (0.3 mole) of sodium hydroxide is added to the flask, heated to 40° C. and kept for 3 hours. 15.62 g (0.045 mole) of hexachlorocyclotriphosphazene is dissolved in 80 mL of dioxane, and the solution is added dropwise to the reaction system, heated to 70° C. and stirred for 48 hours. After the reaction is completed, the solution is cooled to room temperature and filtered to remove the generated solids, and the filtrate is concentrated by rotary evaporation to remove the solvent. Then, the crude product is washed three times with ethanol to obtain a white solid powder.

Then, with reference to the method of Synthesis Example 2, the 1 mole of hexakis(4-vinylphenoxy)cyclotriphosphazene is changed into 1 mole of the white solid powder (about 891 g), and the other steps are the same, thereby obtaining compound 1, as shown in the structure of Formula (C-1) below:

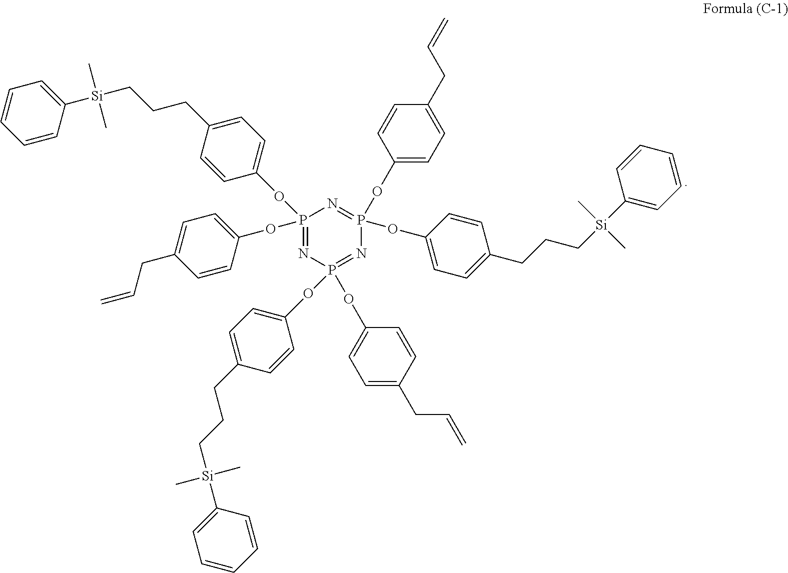 [SMILES: C=CCc1ccc(OP2(Oc3ccc(CCC[Si](C)(C)c4ccccc4)cc3)=NP(Oc3ccc(CC=C)cc3)(Oc3ccc(CCC[Si](C)(C)c4ccccc4)cc3)=NP(Oc3ccc(CC=C)cc3)(Oc3ccc(CCC[Si](C)(C)c4ccccc4)cc3)=N2)cc1]

### Comparative Synthesis Example 2: Preparation of Compound 2

As the hexachlorocyclotriphosphazene, 4-vinylphenol and phenol are used as main raw materials, a p-Vinylphenylcyclotriphosphazene compound (i.e., compound 2), as shown in the structure of Formula (C-2) below, is synthesized by a two-step nucleophilic substitution reaction using a stepwise addition method,

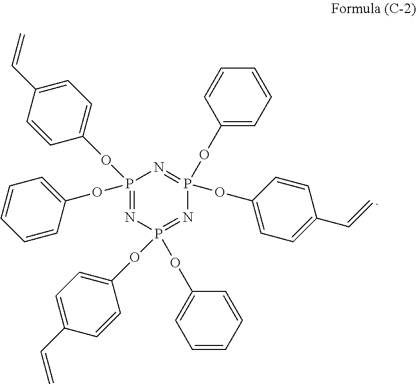 [SMILES: C=Cc1ccc(OP2(Oc3ccccc3)=NP(Oc3ccccc3)(Oc3ccc(C=C)cc3)=NP(Oc3ccccc3)(Oc3ccc(C=C)cc3)=N2)cc1]

### Comparative Synthesis Example 3: Preparation of Compound 3

Compound 3 (shown in the structure of Formula (C-3)) is obtained by reference to the preparation method of patent CN116003468A,

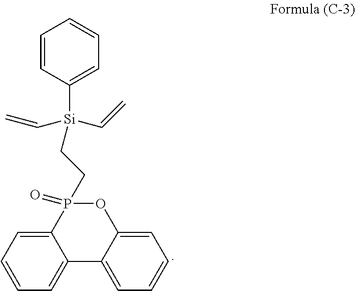 [SMILES: C=C[Si](C=C)(CCP1(=O)Oc2ccccc2-c2ccccc21)c1ccccc1]

### Comparative Synthesis Example 4: Preparation of Compound 4

With reference to Synthesis Example 2, the dimethylphenylsilane is changed into a phenyltri(dimethylsiloxane)silane (available from Suzhou Siso New Material Co., Ltd.), and the other steps are the same, thereby obtaining compound 4.

### Comparative Synthesis Example 5: Preparation of Compound 5

With reference to Synthesis Example 1, the hexakis(4-vinylphenoxy)cyclotriphosphazene is changed into an allylphosphazene SPV-100 (available from Otsuka Chemical Co., Ltd.), the amount of dimethylphenylsilane is change into 1 mole, and the other steps are the same, thereby obtaining compound 5, as shown in the structure of Formula (C-5),

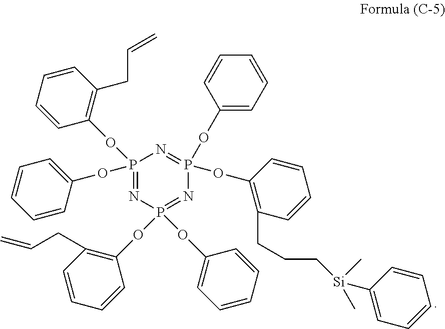 [SMILES: C=CCc1ccccc1OP1(Oc2ccccc2)=NP(Oc2ccccc2)(Oc2ccccc2CC=C)=NP(Oc2ccccc2)(Oc2ccccc2CCC[Si](C)(C)c2ccccc2)=N1]

### Characteristic of Compound B

Compared to the hexakis(4-vinylphenoxy)cyclotriphosphazene containing phosphazene ring and the reactive vinyl group, the compound of Formula (I) has a longer shelf life. For instance, in one exemplary embodiment, at a temperature between 0° C. and 8° C., the shelf life of the hexakis(4-vinylphenoxy)cyclotriphosphazene is 8 weeks, while the shelf life of compound B is over 6 months. The long shelf life indicates that the properties of compound B are stable and that the raw materials can be easily preserved.

In addition, compound B and the hexakis(4-vinylphenoxy)cyclotriphosphazene are used as samples, and the gel times (SG) thereof are measured by reference to IPC-TM-650 2.3.18. 2.0 mL of each sample is placed on a cure plate with a temperature of 171±0.5° C. Use a sharp bamboo stick to stroke from the center of the glue to the edge, and keep the diameter of the glue area to be ranged from 1.90 centimeter (cm) to 2.19 cm. Each sample is stirred until beginning to clump and continuously stirred until the largest glue block breaks. Meanwhile, the timer is stopped and the time is recorded in seconds. The measured time is the gel time. The gel times are measured by using the same method when the temperature of the cure plate is 131±0.5° C. and 151±0.5° C.

The gel times (SG) of compound B and the hexakis(4-vinylphenoxy)cyclotriphosphazene obtained by the method mentioned above are shown as the following:

| | SG/131° C. | | SG/151° C. | | SG/171° C. |
|---|---|---|---|---|---|
| Compound B | >10 | minutes | 177 | seconds | 88 seconds |
| Hexakis(4- | 55 | seconds | 20 | seconds | 10 seconds |
| vinylphenoxy)- | | | | | |
| cyclotriphosphazene | | | | | |

According to the testing results mentioned above, it can be found that the gel time of compound B is longer than the gel time of the hexakis(4-vinylphenoxy)cyclotriphosphazene at each temperature, which indicates that the reactivity of compound B is slowed down and a longer reaction operation window may be provided.

The purified compound B is analyzed by infrared (FTIR), nuclear magnetic resonance (¹H NMR) and high performance liquid chromatography (HPLC).

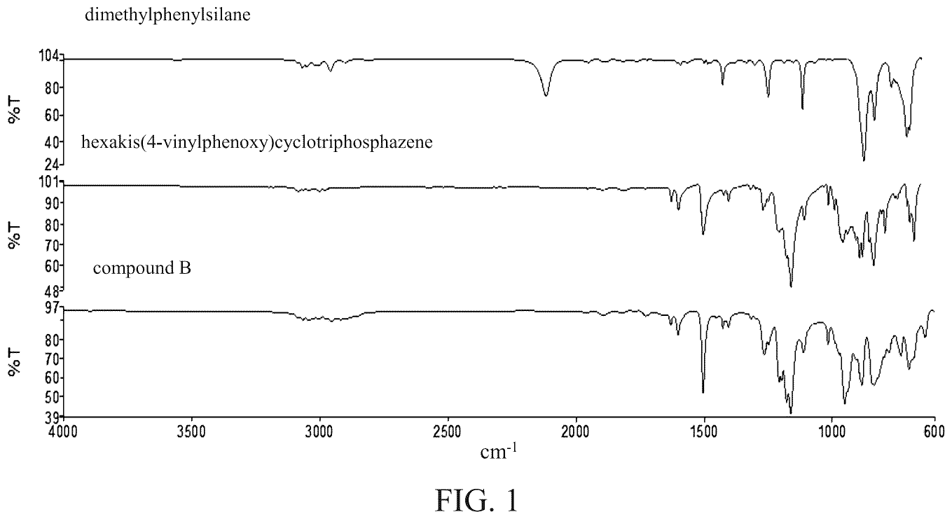

The upper, middle and lower curves in FIG. 1 represent FTIR spectrums of the raw material dimethylphenylsilane, the raw material hexakis(4-vinylphenoxy)cyclotriphosphazene and the product compound B, respectively.

In the FTIR spectrum of the dimethylphenylsilane, a Si—H bond stretching vibrational absorption peak at 2200 cm⁻¹ can be found. By comparison, it can be found that in the FTIR spectrum of compound B, the Si—H bond stretching vibrational absorption peak at 2200 cm⁻¹ is disappeared, indicating the Si—H bond of the dimethylphenylsilane are completely reacted, while the characteristic peaks of Si—C are appeared at 800 cm⁻¹ and 960 cm¹, proving that the dimethylphenylsilane reacted with the hexakis(4-vinylphenoxy)cyclotriphosphazene, which corresponds to the expected structure of the compound.

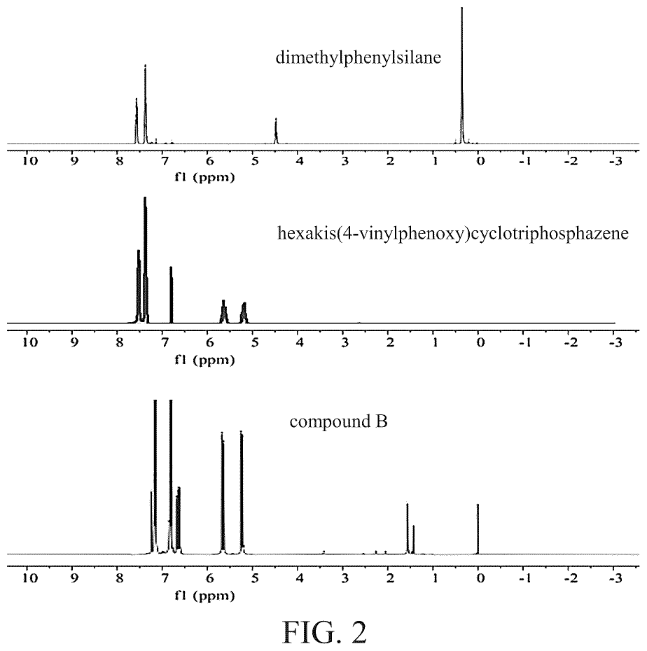

The upper, middle and lower curves in FIG. 2 represent ¹H NMR spectrums of a raw material dimethylphenylsilane, a raw material hexakis(4-vinylphenoxy)cyclotriphosphazene and a product compound B, respectively.

Among them, in the upper ¹H NMR spectrum of the dimethylphenylsilane, the chemical shift δ=0.0-1.0 ppm is the proton peak of —CH₃ of the dimethylphenylsilane; δ=4.0-5.0 ppm is the proton peak of Si—H of the dimethylphenylsilane. Compared to the middle ¹H NMR spectrum of the hexakis(4-vinylphenoxy)cyclotriphosphazene and the lower ¹H NMR spectrum of the compound B, in the ¹H NMR spectrum of the compound B, the proton peak on the benzene is found at δ=7.0-7.5 ppm and proton peaks on the carbon-carbon double bond are found at δ=5-6 ppm and δ=6.5-7.0 ppm, which are basically consistent with the chemical shifts of the proton peaks of the hexakis(4-vinylphenoxy)cyclotriphosphazene; new methyl and methylene peaks appear at δ=1.0-2.0 ppm and the proton peak of Si—H at δ=4.0-5.0 ppm is disappeared, which indicates the Si—H bond of the dimethylphenylsilane has been reacted and has hydrosilylated with the hexakis(4-vinylphenoxy)cyclotriphosphazene, thereby obtaining the compound B.

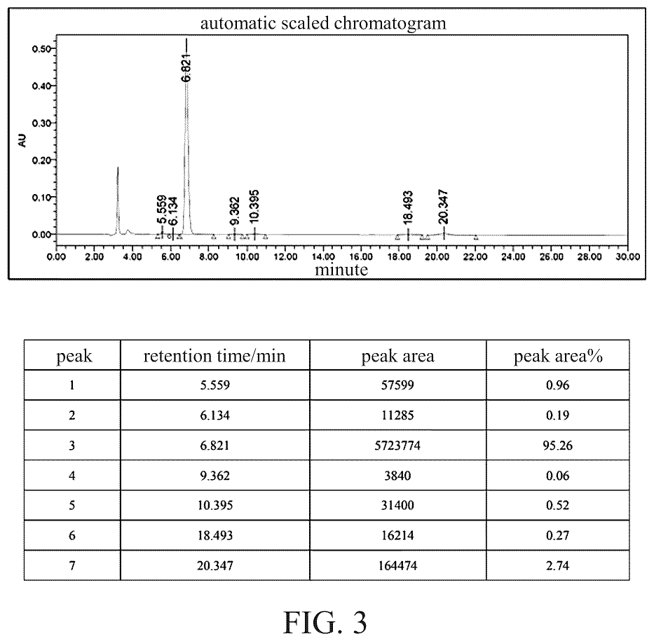

FIG. 3 is a HPLC curve of the product compound B. In the HPLC curve, the strongest peak appears at a retention time of 6.821 minutes, with a peak area of 95.26%, proving that the purity of the compound B exceeds 95%.

Another object of the present disclosure is to provide a resin composition, comprising the compound of Formula (I), a vinyl group-containing polyphenylene ether resin, and a vinyl group-containing crosslinking agent, wherein:

The amount of the vinyl group-containing polyphenylene ether resin is 100 parts by weight, the amount of the vinyl group-containing crosslinking agent is 15 parts by weight to 45 parts by weight, and the amount of the compound of Formula (I) is 80 parts by weight to 120 parts by weight.

For instance, in one exemplary embodiment, the vinyl group-containing polyphenylene ether resin used herein refers to a polyphenylene ether compound or a mixture having an ethylenic carbon-carbon double bond (C═C) or a functional group derived therefrom. Examples of the ethylenic carbon-carbon double bond (C═C) or the functional group derived therefrom may include a structure containing a vinyl group, a vinylene group, an allyl group, a vinylbenzyl group, a methacrylate group or the like, but the present disclosure is not limited thereto. the position of the functional group is not particularly limited and may be located at the terminal of a long-chain structure. In other words, for instance, in the present disclosure, the vinyl group-containing polyphenylene ether resin represents a polyphenylene ether resin containing a reactive vinyl group or a functional group derived therefrom. Examples of the vinyl group-containing polyphenylene ether resin include a polyphenylene ether resin containing a vinyl group, a vinylene group, an allyl group, a vinylbenzyl group, or a methacrylate group, but the present disclosure is not limited thereto.

For instance, in one exemplary embodiment, the vinyl group-containing polyphenylene ether resin used herein includes a vinylbenzyl group-terminated polyphenylene ether resin, a methacrylate group-terminated polyphenylene ether resin, an allyl group-terminated polyphenylene ether resin or a combination thereof.

For instance, the vinylbenzyl group-terminated polyphenylene ether resin and the methacrylate group-terminated polyphenylene ether resin comprise structures represented by Formula (A-1) and Formula (A-2), respectively:

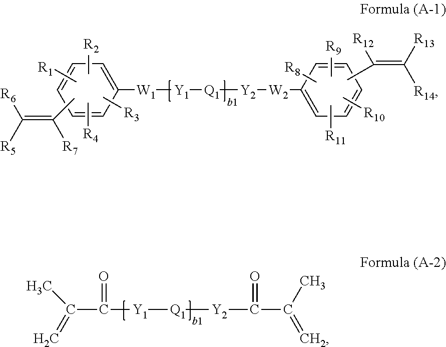

wherein, each of R₁ to R₁₄ is independently a hydrogen atom or —CH₃, and each of W₁ and W₂ is independently a C₁ to C₃ divalent aliphatic group;
b1 is an integer of 0 to 8;
Q₁ comprises any one of structures represented by Formula (B-1), Formula (B-2) and Formula (B-3) or a combination thereof:

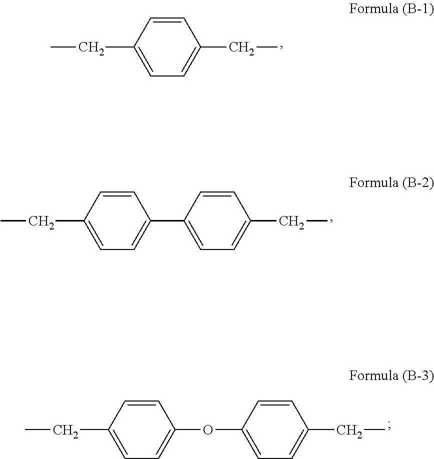

each of Y₁ and Y₂ independently comprises a structure represented by Formula (B-4):

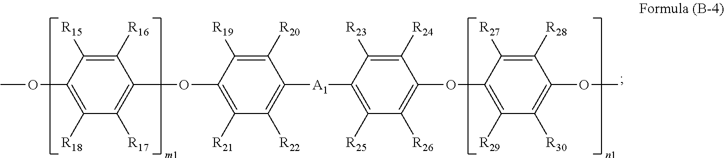

wherein, each of R₁₅ to R₃₀ is independently a hydrogen atom or —CH₃, each of m1 and n1 is independently an integer of 1 to 30, and A1 is selected from a covalent bond, —CH₂—, —CH(CH₃)—, —C(CH₃)₂—, —O—, —S—, —SO₂— and a carbonyl group.

For instance, the vinyl group-containing polyphenylene ether resin may be a (meth)acrylyl group-containing polyphenylene ether resin (such as SA9000, available from Sabic), a vinylbenzyl group-containing polyphenylene ether resin with a number average molecular weight of about 1200 (such as OPE-2st 1200, available from Mitsubishi Gas Chemical Co., Inc.), a vinylbenzyl group-containing polyphenylene ether resin with a number average molecular weight of about 2200 (such as OPE-2st 2200, available from Mitsubishi Gas Chemical Co., Inc.), a vinylbenzyl group-modified bisphenol A polyphenylene ether resin with a number average molecular weight of about 2400 to 2800, a vinyl group-containing chain-extended polyphenylene ether resin with a number average molecular weight of about 2200 to 3000 or a combination of the aforementioned resins. Among them, the vinyl group-chain-extended polyphenylene ether resin may include various polyphenylene ether resins disclosed in the US Patent Application Publication No. 2016/0185904 A1, all of which are incorporated herein by reference in their entirety.

For instance, in one exemplary embodiment, the vinyl group-containing crosslinking agent used herein refers to a compound, a polymer or a mixture containing an ethylenic carbon-carbon double bond (C═C) or a functional group derived therefrom in the molecule and being able to carry out a crosslinking reaction with a vinyl group-containing polyphenylene ether resin. In addition, the vinyl group-containing crosslinking agent is different from the aforesaid vinyl group-containing polyphenylene ether resin.

For instance, the vinyl group-containing crosslinking agent refers to a vinyl group-containing compound or a polymer with a molecular weight of less than or equal to 5,000, preferably between 100 and 4,000 and more preferably between 100 and 3,000. The vinyl group-containing crosslinking agent comprises styrene, divinylbenzene, divinylnaphthalene, divinylbiphenyl, tert-butylstyrene, bis(vinylbenzyl)ether, 1,2,4-trivinyl cyclohexane (TVCH), bis(vinylphenyl)ethane (BVPE), bis(vinylphenyl)hexane, bis(vinylphenyl)dimethylene ether, bis(vinylphenyl) dimethylene benzene, triallyl isocyanurate (TAIC), triallyl cyanurate (TAC), diallyl bisphenol A, butadiene, decadiene, octadiene, vinylcarbazole, acrylate or a combination thereof, but the present disclosure is not limited thereto. These components also include their isomers or polymers.

For instance, in one exemplary embodiment, the resin composition may further comprise a polyolefin resin. The polyolefin resin includes any one of a polybutadiene, a polyisoprene, a styrene-butadiene copolymer, a styrene-isoprene copolymer, a styrene-butadiene-divinylbenzene terpolymer, an ethylene-divinylbenzene-styrene polymer, a styrene-divinylbenzene-ethylstyrene polymer, a styrene-butadiene-styrene copolymer, a maleic anhydride-adducted styrene-butadiene copolymer, a vinyl-polybutadiene-urethane polymer, a maleic anhydride-adducted polybutadiene, a polymethylstyrene, an ethylene propylene diene monomer, a petroleum resin, a cycloolefin copolymer, a hydrogenated polybutadiene, a hydrogenated polyisoprene, a hydrogenated styrene-butadiene-divinylbenzene terpolymer, a hydrogenated styrene-butadiene-styrene copolymer, a hydrogenated maleic anhydride-adducted styrene-butadiene copolymer, a hydrogenated styrene-butadiene copolymer or a hydrogenated styrene-isoprene copolymer or a combination thereof.

The amount of the polyolefin resin is not particularly limited. In one exemplary embodiment, with respect to a total of 100 parts by weight of the vinyl group-containing polyphenylene ether resin, the resin composition may comprise 20 parts by weight to 60 parts by weight of the polyolefin resin. Preferably, the resin composition may comprise 30 parts by weight to 50 parts by weight of the polyolefin resin.

The resin composition of the present disclosure may comprise a maleimide resin, a maleimide triazine resin, a styrene maleic anhydride resin, an epoxy resin, a phenolic resin, a benzoxazine resin, a cyanate ester resin, a polyester resin, a polyamide resin, a polyimide resin or a combination thereof as needed.

In one exemplary embodiment, the resin composition comprises a maleimide resin. The maleimide resin may be a multi-functional maleimide resin. The multi-functional maleimide resin may comprise 4,4′-diphenylmethane bismaleimide, oligomer of phenylmethane maleimide, biphenyl aralkyl bismaleimide, bismaleimide containing indane structure, m-phenylene bismaleimide, bisphenol A diphenyl ether bismaleimide, 3,3′-dimethyl-5,5′-diethyl-4,4′-diphenyl methane bismaleimide, 4-methyl-1,3-phenylene bismaleimide, 1,6-bismaleimide-(2,2,4-trimethyl)hexane, multi-functional maleimide resin containing aliphatic long-chain structure or a combination thereof, but the present disclosure is not limited thereto.

For instance, the maleimide resin may be the maleimide resin products BMI-1000, BMI-1000H, BMI-1100, BMI-1100H, BMI-2000, BMI-2300, BMI-3000, BMI-3000H, BMI-4000H, BMI-5000, BMI-5100, BMI-7000, BMI-7000H available from Daiwakasei Industry, the maleimide resin products BMI-70 and BMI-80 available from K.I Chemical Industry Co., Ltd, or the maleimide resin products X9-470, NE-X-9470S and NE-X-9480 available from D.I.C. (Dainippon Ink & Chemicals, Inc.) Corporation.

For instance, the maleimide resin containing aliphatic long-chain structure may be the maleimide resin products BMI-689, BMI-1400, BMI-1500, BMI-1700, BMI-2500, BMI-3000, BMI-5000, BMI-6000 available from Designer Molecules Inc. The maleimide resin containing aliphatic long-chain structure may have at least one maleimide group bonded to a substituted or unsubstituted long-chain aliphatic group. The long-chain aliphatic group may be a C₅ to C₅₀ aliphatic group, such as C₁₀ to C₅₀, C₂₀ to C₅₀, C₃₀ to C₅₀, C₂₀ to C₄₀, or C₃₀ to C₄₀, but the present disclosure is not limited thereto.

In one exemplary embodiment, the resin composition comprises a maleimide triazine resin. The maleimide triazine resin may be any one or more maleimide triazine resins applicable to preparing a prepreg, a resin film, a laminate, a printed circuit board or a cured insulator. The maleimide triazine resin may be obtained by polymerizing a cyanate ester resin and a maleimide resin, particularly may be obtained by polymerizing bisphenol A cyanate ester resin and maleimide resin, by polymerizing bisphenol F cyanate ester resin and maleimide resin, by polymerizing phenol novolac cyanate ester resin and maleimide resin or by polymerizing dicyclopentadiene-containing cyanate ester resin and maleimide resin. The maleimide triazine resin may be obtained by polymerizing the cyanate ester resin and the maleimide resin in any molar ratio, particularly be obtained by polymerizing a cyanate resin and a maleimide resin in a molar ratio of (1 to 10):1, particularly (1 to 6):1, and more particularly 1:1, 2:1, 4:1, or 6:1.

In one exemplary embodiment, the resin composition comprises a styrene maleic anhydride resin. The molar ratio of styrene to maleic anhydride in the styrene maleic anhydride resin may be (1 to 8):1, such as 1:1, 2:1, 3:1, 4:1, 6:1 or 8:1. The styrene maleic anhydride resin may be a styrene maleic anhydride copolymer. The styrene maleic anhydride copolymer may be the styrene maleic anhydride copolymer products SMA-1000, SMA-2000, SMA-3000, EF-30, EF-40, EF-60 and EF-80 available from Cray Valley, or the styrene maleic anhydride copolymer products C400, C500, C700 and C900 available from Polyscope, but the present disclosure is not limited thereto. The styrene maleic anhydride resin may also be an esterified styrene maleic anhydride copolymer. The esterified styrene maleic anhydride copolymer may be esterified styrene maleic anhydride copolymer products SMA1440, SMA17352, SMA2625, SMA3840 and SMA31890 available from Cray Valley, but the present disclosure is not limited thereto. The resin composition may comprise one of the styrene maleic anhydride resin, or comprise a combination of a plurality of the styrene maleic anhydride resins.

In one exemplary embodiment, the resin composition may further comprise an epoxy resin. For instance, the epoxy resin may be various epoxy resins known in this field and may include such as bisphenol A epoxy resin, bisphenol F epoxy resin, bisphenol S epoxy resin, bisphenol AD epoxy resin, novolac epoxy resin (such as multi-functional phenolic epoxy resin), trifunctional epoxy resin, tetrafunctional epoxy resin, dicyclopentadiene (DCPD) epoxy resin, phosphorus-containing epoxy resin, p-xylene epoxy resin, naphthalene epoxy resin (such as naphthol epoxy resin), benzofuran epoxy resin, isocyanate-modified epoxy resin or a combination thereof, but the present disclosure is not limited thereto.

The novolac epoxy resin may be phenol novolac epoxy resin, bisphenol A novolac epoxy resin, bisphenol F novolac epoxy resin, biphenyl novolac epoxy resin, phenol benzaldehyde epoxy resin, phenol aralkyl novolac epoxy resin, o-cresol novolac epoxy resin or a combination thereof.

The phosphorus-containing epoxy resin may be DOPO (9,10-dihydro-9-oxa-10-phosphaphenanthrene-10-oxide) epoxy resin, DOPO-HQ epoxy resin or a combination thereof. The DOPO epoxy resin may be one or more selected from DOPO-containing phenol novolac epoxy resin, DOPO-containing cresol novolac epoxy resin and DOPO-containing bisphenol-A novolac epoxy resin. The DOPO-HQ epoxy resin may be at least one selected from DOPO-HQ-containing phenol novolac epoxy resin, DOPO-HQ-containing cresol novolac epoxy resin and DOPO-HQ-containing bisphenol-A novolac epoxy resin.

In one exemplary embodiment, the epoxy resin may include a biphenyl novolac epoxy resin, a dicyclopentadiene epoxy resin, an o-methylphenol novolac epoxy resin, a naphthol-type epoxy resin or a combination thereof.

In one exemplary embodiment, the resin composition comprises a phenol resin. The phenol resin may be a mono-functional phenol resin, a multi-functional phenol resin or a combination thereof, but the present disclosure is not limited thereto. The phenol resin may include a phenoxy resin, a novolac resin or a combination thereof, but the present disclosure is not limited thereto.

In one exemplary embodiment, the resin composition comprises a benzoxazine resin. The benzoxazine resin may include bisphenol A benzoxazine resin, bisphenol F benzoxazine resin, phenolphthalein benzoxazine resin, dicyclopentadiene benzoxazine resin, phosphorus-containing benzoxazine resin, diamine benzoxazine resin and vinyl group-modified or allyl-modified benzoxazine resin or a combination thereof, but the present disclosure is not limited thereto. The benzoxazine resin may be, for instance, products LZ-8270 (phenolphthalein benzoxazine resin), LZ-8280 (bisphenol F benzoxazine resin) and LZ-8290 (bisphenol A benzoxazine resin) available from Huntsman, or product HFB-2006M available from Showa High Polymer. Among them, the diamine benzoxazine resin may be diaminodiphenylmethane benzoxazine resin, diaminodiphenyl ether benzoxazine resin, diaminodiphenyl sulfone benzoxazine resin, diaminodiphenyl sulfide benzoxazine resin or a combination thereof.

In one exemplary embodiment, the resin composition comprises a cyanate ester resin. The cyanate ester resin may be various cyanate ester resins known in this field. The cyanate ester resin may include a cyanate ester resin with a structure of Ar—O—C≡N (wherein Ar is an aromatic group, such as benzene, naphthalene or anthracene), but the present disclosure is not limited thereto. The cyanate ester resin may include phenol novolac cyanate ester resin, bisphenol A cyanate ester resin, bisphenol A novolac cyanate ester resin, bisphenol F cyanate ester resin, bisphenol F novolac cyanate ester resin, dicyclopentadiene-containing cyanate ester resin, naphthalene-containing cyanate ester resin, phenolphthalein cyanate ester resin or a combination thereof. Among them, the novolac cyanate ester resin may be bisphenol A novolac cyanate ester resin, bisphenol F novolac cyanate ester resin or a combination thereof, but the present disclosure is not limited thereto. The cyanate ester resin may include the cyanate ester resin products Primaset PT-15, PT-30S, PT-60S, BA-200, BA-230S, BA-3000S, BTP-2500, BTP-6020S, DT-4000, DT-7000, ULL950S, HTL-300, CE-320, LVT-50, LeCy available from Lonza or a combination thereof, but the present disclosure is not limited thereto.

In one exemplary embodiment, the resin composition comprises a polyester resin. The polyester resin may be obtained by esterification of an aromatic compound with two carboxylic groups and an aromatic compound with two hydroxyl groups. The polyester resin may be HPC-8000, HPC-8150, HPC-8200 available from D.I.C. Corporation or a combination thereof, but the present disclosure is not limited thereto.

In one exemplary embodiment, the resin composition comprises a polyamide resin. The polyamide resin may be various polyamide resins known in this field and may include various commercially available polyamide resin products, but the present disclosure is not limited thereto.

In one exemplary embodiment, the resin composition comprises a polyimide resin. The polyimide resin may be various polyimide resins known in this field and may include various commercially available polyimide resin products, but the present disclosure is not limited thereto.

In one exemplary embodiment, the resin composition of the present disclosure may further comprise an amine curing agent, a flame retardant, an inorganic filler, a curing accelerator, a polymerization inhibitor, a coloring agent, a solvent, a toughening agent, a silane coupling agent or a combination thereof as needed.

In one exemplary embodiment, the resin composition comprises an amine curing agent. The amine curing agent may include dicyandiamide, diaminodiphenyl sulfone, diaminodiphenyl methane, diaminodiphenyl ether, diaminodiphenyl sulfide or a combination thereof, but the present disclosure is not limited thereto.

In one exemplary embodiment, the resin composition comprises a flame retardant. The flame retardant may be any one or more flame retardants applicable to preparing a prepreg, a resin film, a laminate, a printed circuit board or a cured insulator.

The flame retardant may be a phosphorus-containing flame retardant. The flame retardant may be ammonium polyphosphate, hydroquinone bis-(diphenylphosphate), bisphenol A bis-(diphenylphosphate), tri(2-carboxyethyl) phosphine (TCEP), phosphoric acid tris(chloroisopropyl) ester, trimethyl phosphate (TMP), dimethyl methyl phosphonate (DMMP), resorcinol bis(dixylenyl phosphate) (RDXP, such as commercially available PX-200, PX-201, and PX-202), phosphazene (such as commercially available SPB-100, SPH-100, and SPV-100), melamine polyphosphate, DOPO and its derivatives or resins, diphenylphosphine oxide (DPPO) and its derivatives or resins, melamine cyanurate, tri-hydroxy ethyl isocyanurate, aluminium phosphinate (such as commercially available OP-930 and OP-935) or a combination thereof, the flame retardant may be a flame retardant commercially available from Katayama Chemical Industries Co., Ltd., such as V1, V2, V3, V4, V5, V7, S-2, S-4, E-4c, E-7c, E-8g, E-9g, E-10g, E-100, B-3, W-1o, W-2h, W-2o, W-3o, W-4o, OX-1, OX-2, OX-4, OX-6, OX-6+, OX-7, OX-7+, OX-13, BPE-1, BPE-3, HyP-2, API-9, CMPO, ME-20, C-1R, C-1S, C-3R, C-3S, C-11R or a combination thereof, but the present disclosure is not limited thereto.

The flame retardant may be a DPPO compound (e.g., di-DPPO compound), a DOPO compound (e.g., di-DOPO compound), a DOPO resin (e.g., DOPO-HQ, DOPO-NQ, DOPO-PN, and DOPO-BPN), and a DOPO-containing epoxy resin or a combination thereof, but the present disclosure is not limited thereto, wherein DOPO-PN is a DOPO-containing phenolic novolac compound, and DOPO-BPN may be a bisphenol novolac compound, such as DOPO-BPAN (DOPO-bisphenol A novolac), DOPO-BPFN (DOPO-bisphenol F novolac) or DOPO-BPSN (DOPO-bisphenol S novolac). For instance, in one exemplary embodiment, with respect to a total of 100 parts by weight of the vinyl group-containing polyphenylene ether resin, the resin composition of the present disclosure may further comprise 1 part by weight to 20 parts by weight of the flame retardant, preferably 5 parts by weight to 10 parts by weight of the flame retardant, but the present disclosure is not limited thereto.

In one exemplary embodiment, the resin composition comprises an inorganic filler. The inorganic filler may be any one or more inorganic fillers applicable to preparing a prepreg, a resin film, a laminate, a printed circuit board or a cured insulator. The inorganic filler may be silica (fused, non-fused, porous or hollow type), aluminum oxide, aluminum hydroxide, magnesium oxide, magnesium hydroxide, calcium carbonate, aluminum nitride, boron nitride, aluminum silicon carbide, silicon carbide, titanium dioxide, zinc oxide, zirconium oxide, mica, boehmite (AlOOH), calcined talc, talc, silicon nitride, calcined kaolin or a combination thereof, but the present disclosure is not limited thereto. The inorganic filler may be spherical, fibrous, plate-like, particulate, flake-like or whisker-like. The inorganic filler may be pretreated by a silane coupling agent (particularly aminosilane coupling agent). The inorganic filler may be a spherical silica whose surface is treated by an aminosilane coupling agent.

The amount of the inorganic filler is not particularly limited. In one exemplary embodiment, with respect to a total of 100 parts by weight of all the resin other than the silane coupling agent, the curing accelerator, the solvent and the inorganic filler in the resin composition, the resin composition may comprise 20 parts by weight to 200 parts by weight of the inorganic filler, preferably 50 parts by weight to 150 parts by weight of the inorganic filler, but the present disclosure is not limited thereto.

In one exemplary embodiment, the resin composition comprises a curing accelerator. The curing accelerator may include a catalyst, such as a Lewis base or a Lewis acid. The Lewis base may include imidazole, boron trifluoride-amine complex, ethyltriphenyl phosphonium chloride, 2-methylimidazole (2MI), 2-phenyl-1H-imidazole (2PZ), 2-ethyl-4-methylimidazole (2E4MZ), triphenylphosphine (TPP) and 4-dimethylaminopyridine (DMAP) or a combination thereof, but the present disclosure is not limited thereto. The Lewis acid may include metal salt compounds, such as metal salt compounds of manganese, iron, cobalt, nickel, copper and zinc, particularly zinc octanoate or cobalt octanoate, but the present disclosure is not limited thereto. The curing accelerator may include a curing initiator. The curing initiator may include a peroxide capable of producing free radicals. The curing initiator includes The curing initiator includes 2,3-dimethyl-2,3-diphenylbutane, diisopropylbenzene peroxide, tert-butyl peroxybenzoate, tert-butyl peroxyisopropyl monocarbonate, dibenzoyl peroxide (BPO), 2,5-dimethyl-2,5-di(tert-butylperoxy)-3-hexyne (25B), bis(tert-butylperoxyisopropyl)benzene, azobisisobutyronitrile or a combination thereof, but the present disclosure is not limited thereto. For instance, in one exemplary embodiment, with respect to 100 parts by weight of the vinyl group-containing polyphenylene ether resin, the resin composition of the present disclosure may further include 0.001 parts by weight to 1 part by weight of the curing accelerator, preferably 0.01 parts by weight to 1.0 parts by weight of the curing accelerator, more preferably 0.15 parts by weight to 0.6 parts by weight of the curing accelerator, but the present disclosure is not limited thereto.

In one exemplary embodiment, the resin composition comprises a polymerization inhibitor. The polymerization inhibitor may be various polymerization inhibitors known in this field and may include various commercial polymerization inhibitor products, but the present disclosure is not limited thereto. The polymerization inhibitor may include 1,1-diphenyl-2-picrylhydrazyl radical, methyl acrylonitrile, dithioester, nitroxide-mediated radical, triphenylmethyl radical, metal ion radical, sulfur radical, hydroquinone, p-methoxyphenol, p-benzoquinone, phenothiazine, β-phenylnaphthylamine, p-tert-butylcatechol, methylene blue, 4,4′-butylidenebis(6-tert-butyl-3-methylphenol), 2,2′-methylenebis(4-ethyl-6-t-butylphenol) or a combination thereof, but the present disclosure is not limited thereto. The polymerization inhibitor may comprise or consist of nitroxide radical. The nitroxide-mediated radical may include nitroxide radicals derived from cyclic hydroxylamines, such as 2,2,6,6-substituted piperidine 1-oxyl free radical, 2,2,5,5-substituted pyrrolidine 1-oxyl free radical or a combination thereof, but the present disclosure is not limited thereto. The “substituent” herein is, for instance, an alkyl group having 4 or fewer carbon atoms, such as methyl, ethyl, propyl, butyl, and particularly methyl or ethyl. The nitroxide-mediated radical may be 2,2,6,6-tetramethylpiperidin-1-oxyl free radical, 2,2,6,6-tetraethylpiperidin-1-oxyl free radical, 2,2,6,6-tetramethyl-4-oxopiperidin-1-oxyl free radical, 2,2,5,5-tetramethylpyrrolidine-1-oxyl free radical, 1,1,3,3-tetramethylisoindoline-2-oxyl free radical, N,N-di-tert-butylamine oxygen free radical or a combination thereof, but the present disclosure is not limited thereto. The nitroxide radicals may also be replaced by using stable radicals such as galvinoxyl radicals. The polymerization inhibitor also may be products derived from the polymerization inhibitor with its hydrogen atom or group substituted by other atom or group, such as products derived from a polymerization inhibitor with its hydrogen atom substituted by an amino group, a hydroxyl group, a carbonyl group or the like.

In one exemplary embodiment, the resin composition comprises a coloring agent. The coloring agent may include a dye or a pigment, but the present disclosure is not limited thereto.

In one exemplary embodiment, the resin composition comprises a solvent. Adding solvent may modify the solid content of the resin composition, and adjust the viscosity of the resin composition. The solvent may include methanol, ethanol, ethylene glycol monomethyl ether, acetone, butanone (i.e., methyl ethyl ketone), methyl isobutyl ketone, cyclohexanone, toluene, xylene, methoxyethyl acetate, ethoxyethyl acetate, propoxyethyl acetate, ethyl acetate, dimethyl formamide, dimethyl acetamide, propylene glycol methyl ether or a combination thereof, but the present disclosure is not limited thereto. The solvent added to the resin composition may be evaporated and removed during the processing of the resin composition into a prepreg or a resin film, so that the insulation layer of the prepreg or the resin film does not contain solvent or only contains a trace amount of solvent of less than or equal to 3 wt % (i.e., 3% by weight). Therefore, the presence or absence of the solvent in the resin composition does not affect the properties of the article.

In one exemplary embodiment, the resin composition comprises a toughening agent. The toughening agent may improve the toughness of the resin composition. The toughening agent may include carboxyl-terminated butadiene acrylonitrile rubber (CTBN), core-shell rubber or a combination thereof, but the present disclosure is not limited thereto.

In one exemplary embodiment, the resin composition comprises a silane coupling agent. The silane coupling agent may include silane, and the silane may include siloxane, but the present disclosure is not limited thereto. The silane coupling agent may include amino silane, epoxide silane, vinyl silane, acryloxy silane, methacryloxy silane, hydroxyl silane, isocyanate silane, methacryloyloxy silane and acryloyloxy silane or a combination thereof, but the present disclosure is not limited thereto.

The resin composition of the above embodiments may be made into various articles, such as components applicable to various electronic devices, including a prepreg, a resin film, a laminate, a printed circuit board or a cured insulator, but the present disclosure is not limited thereto.

The article may comprise the resin composition in a semi-cured state (B-stage) or in a cured state (C-stage). The article may comprise a resin layer, and the resin layer is the resin composition in a semi-cured state or a cured state. The article may comprise an insulation layer, and the insulation layer is the resin composition in a cured state.

In one exemplary embodiment, the present disclosure provides a prepreg. The prepreg may comprise a reinforcement material and a semi-cured layer disposed on the reinforcement material, wherein the semi-cured layer is the resin composition in the semi-cured state. The semi-cured layer may be obtained by heating the resin composition to a semi-cured state. In one exemplary embodiment, the present disclosure provides a preparation method of the prepreg, comprising: disposing the resin composition on the reinforcement material, semi-curing the resin composition, particularly heating the resin composition, and forming a prepreg comprising the reinforcement material and the semi-cured layer. The step of disposing the resin composition on the reinforcement material may include coating the resin composition on the reinforcement material. The heating may be baking. The heating step may involve heating to a semi-curing temperature. The semi-curing temperature may be between 100° C. and 200° C. The reinforcement material may be fiber material, woven fabric and non-woven fabric or a combination thereof, but the present disclosure is not limited thereto. The woven fabric may include glass fiber fabric. The types of the glass fiber fabrics are not particularly limited and may be commercially available glass fiber fabrics applicable to various printed circuit boards. The glass fiber fabric may be E-glass fabric, D-glass fabric, S-glass fabric, T-glass fabric, L-glass fabric or Q-glass fabric, wherein the types of the fiber may include yarns and rovings, in spread form or standard form. The woven fabric may include liquid crystal resin woven fabric. The liquid crystal resin woven fabric may include polyester woven fabric, polyurethane woven fabric or a combination thereof, but the present disclosure is not limited thereto. The non-woven fabric may include liquid crystal resin non-woven fabric. The liquid crystal resin non-woven fabric may include polyester non-woven fabric, polyurethane non-woven fabric or a combination thereof, but the present disclosure is not limited thereto. For instance, the reinforcement material may increase the mechanical strength of the prepreg. In one exemplary embodiment, the reinforcement material may be pre-treated by a silane coupling agent.

In one exemplary embodiment, the present disclosure provides a resin film. The resin film may include the resin composition in the semi-cured state. In one aspect, the present disclosure provides a preparation method of the resin film, comprising: semi-curing the resin composition, particularly heating the resin composition. The preparation method of the resin film may further comprise: coating the resin composition on a substrate. In one exemplary embodiment, the present disclosure provides a resin film combination, comprising a substrate and the resin film disposed on the substrate. In one aspect, the present disclosure provides a preparation method of the resin film combination, comprising: providing a substrate and disposing the resin film on the substrate. In one exemplary embodiment, the step of disposing the resin film on the substrate comprises coating the resin composition on the substrate and semi-curing the resin composition, particularly heating the resin composition. The substrate may be a polyethylene terephthalate film (PET film), a polyimide film (PI film), a copper foil or a resin-coated copper or a combination thereof, but the present disclosure is not limited thereto. The heating may be baking. The heating step may involve heating to a semi-curing temperature. The semi-curing temperature may be between 100° C. and 200° C.

In one exemplary embodiment, the present disclosure provides a laminate. The laminate may comprise at least two metal foils and an insulation layer disposed between the metal foils. In one exemplary embodiment, the insulation layer separates the metal foils. The metal foil may include copper, aluminum, nickel, platinum, silver, gold or an ally thereof, particularly copper foil. The insulation layers may be made by heating and curing the resin composition or the semi-cured resin composition. The heating may be baking. The heating and curing steps may involve heating to a curing temperature. The curing temperature may be between 180° C. and 250° C., particularly between 210° C. and 240° C. The curing time may be 80 minutes to 180 minutes, particularly 100 minutes to 150 minutes. The curing step may further comprises applying pressure to the semi-cured resin composition. The insulation layer may be formed by curing the prepreg or the resin film (C-stage). For instance, the laminate may be a copper-clad laminate (CCL).

The laminate may be further processed through a circuit processing to form a circuit board, such as a printed circuit board. One preparing method of the printed circuit board of the present disclosure may be as the following: A double-sided copper-clad laminate (such as product EM-890, available from Elite Electronic Material Co., Ltd.) with a certain thickness such as 28 mil and having 0.5-ounce (oz) HVLP (hyper very low profile) copper foils may be used and subject to drilling and then electroplating, so as to form an electrical conduction between the upper layer copper foil and the bottom layer copper foil. Then, the upper layer copper foil and the bottom layer copper foil are etched to form an inner layer circuit board. Then, brown oxidation and roughening are performed on the inner layer circuit board to form uneven structures on the surface to increase roughness. Next, a copper foil, the prepreg, the inner layer circuit board, the prepreg and a copper foil are stacked in sequence, and then heated at 180° C. to 250° C. for 80 minutes to 180 minutes by a vacuum lamination apparatus to cure the material of the insulation layer of the prepregs. Next, black oxidation, drilling, copper plating and other circuit board processes known in the field are performed on the outmost copper foil so as to obtain the printed circuit board.

In one exemplary embodiment, the present disclosure provides a cured insulator. In one exemplary embodiment, the present disclosure provides a preparation method of the cured insulator, comprising: curing the resin composition through a curing process one time or multiple times, wherein the multiple times refers to greater than or equal to two times. For instance, the resin composition may be semi-cured, particularly heated, to obtain a semi-cured resin composition and then the semi-cured resin composition may be further cured, particularly heated, to obtain a cured resin composition. The cured insulator may include the resin composition in a cured state, the resin composition in a cured state containing reinforcement materials or a combination thereof. The heating may be baking. In one exemplary embodiment, the semi-cured resin composition is heated to a semi-curing temperature. The semi-curing temperature may be 100° C. to 200° C.

In one exemplary embodiment, the step of curing the resin composition or curing the semi-cured resin composition one time involves heating to a curing temperature. The curing temperature may be between 180° C. and 250° C., preferably between 210° C. and 240° C. In one exemplary embodiment, the curing time is 80 minutes to 180 minutes, particularly 100 minutes to 150 minutes. The curing step may further comprise applying pressure to the resin composition or the semi-cured resin composition.

The cured insulator may include the resin composition in the cured stage. In one exemplary embodiment, the present disclosure provides a preparation method of the cured insulator, comprising: curing the resin film, particularly heating the resin film. The preparation method of the cured insulator may further comprise coating the resin composition on a substrate, and/or semi-curing the resin composition, and forming the resin film.

The cured insulator may include the resin composition in the cured stage containing a reinforcement material. In one exemplary embodiment, the present disclosure provides a preparation method of the cured insulator, comprising: curing the prepreg, particularly heating the prepreg. The preparation method of the cured insulator may further comprise disposing the resin composition on the reinforcement material, semi-curing the resin composition, particularly heating the resin composition, and forming a prepreg containing the reinforcement material and the semi-cured layer.

The preparation method of the cured insulator may further comprise molding. For instance, the resin composition or the semi-cured resin composition may be placed into a mold, and the resin composition or the semi-cured resin composition may be formed and cured in the mold under a curing temperature and a certain pressure, thereby obtaining a cured insulator with a specific shape.

The cured insulator may be an insulation layer without metal on the surface obtained by removing the metal foil on the surface of the laminate or the printed circuit board.

Preferably, the resin composition of the present disclosure or the article made therefrom may have improvement at least one of the following properties: glass transition temperature, dielectric constant, dissipation factor, thermal resistance after moisture absorption, flame retardancy, inner resin flow, and drop ball test.

For instance, the resin composition of the present disclosure or the article made therefrom may satisfy one or more of the following properties:
a glass transition temperature as measured by a dynamic mechanical analyzer by reference to IPC-TM-650 2.4.24.4 of greater than or equal to 185° C., such as between 185° C. and 232° C.;
a dielectric constant at 10 GHz as measured by reference to JIS C2565 of less than or equal to 3.30, such as between 2.70 and 3.30;
a dissipation factor at 10 GHz as measured by reference to IPC-TM-650 2.4.24.5 of less than or equal to 0.0030, such as between 0.0013 and 0.0030;
no delamination occurs after subjecting the article to a heat resistance after moisture absorption test for 5 hours by reference to IPC-TM-650 2.6.16.1 and IPC-TM-650 2.4.23 (The requirement of the specification of laminate or printed circuit board in the industry is that there is no delamination after the heat resistance test after 1 hour of moisture absorption);
a flame retardancy as measured by reference to UL 94 rating of V-1 or V-0;
an inner resin flow after lamination of an article (such as a sample for inner resin flow test) of greater than or equal to 5 mm, such as between 5 mm and 10 mm; and
a drop-ball height of an article (such as a sample for drop ball test) that causes damage of greater than or equal to 35 cm, such as between 35 cm and 70 cm.

Raw materials below are used to prepare the resin compositions of Examples and Comparative Examples of the present disclosure according to the amount listed in Table 1 to Table 5 and further made into testing samples or articles. The resin compositions and the testing results of Examples and Comparative Examples are shown in Table 1 to Table 5 (in parts by weight).
Compound A: prepared by Synthesis Example 1
Compound B: prepared by Synthesis Example 2
Compound C: prepared by Synthesis Example 3
Compound D: prepared by Synthesis Example 4
Compound E: prepared by Synthesis Example 5
Compound F: prepared by Synthesis Example 6
Hexakis(4-vinylphenoxy)cyclotriphosphazene: available from Weihai Jinwei ChemIndustry Co.
Dimethylphenylsilane: available from Suzhou Siso New Material Co., Ltd.
Compound 1—compound 3: prepared by Comparative Synthesis Example 1—Comparative Synthesis Example 3, respectively
Phenyltrivinylsilane: available from Suzhou Siso New Material Co., Ltd.
Compound 4—compound 5: prepared by Comparative Synthesis Example 4—Comparative Synthesis Example 5, respectively
OPE-2st 2200: vinylbenzyl group-terminated polyphenylene ether resin, available from Mitsubishi Gas Chemical Co.
SA9000: methacrylate group-terminated polyphenylene ether resin, available from Sabic company.
TAIC: triallyl isocyanurate, available from Kingyorker Enterprise Co., Ltd.
DVB: divinylbenzene, available from Merck.
B-1000: polybutadiene, available from Nippon Soda Co., Ltd.
SBS-C: styrene-butadiene block copolymer, available from Nippon Soda Co., Ltd.
D1118: styrene-butadiene-styrene block copolymer (SBS), available from KRATON, wherein the mass ratio of styrene unit to butadiene unit is 30:70.
H1051: hydrogenated styrene-butadiene-styrene block copolymer (SEBS), available from Asahi KASEI.
PX-200: resorcinol bis(diphenyl phosphate) (condensation polymer), also called tetrakis(2,6-dimethylphenyl) 1,3-phenylene bisphosphate (condensation polymer), available from Daihachi Chemical Industry Co., Ltd.
S-2: diethyl p-vinylbenzyl phosphate, available from Katayama Chemical Industries Co., Ltd.
SC-2500SMJ: spherical silica treated by acrylate silane coupling agent, available from Admatechs.
25B: 2,5-dimethyl-2,5-di(tert-butyl peroxy)-3-hexyne, available from Nippon Oils & Fats.
MEK: butanone, which is commercially available and the source thereof is not limited.
Toluene: available from Chambeco Group.

In the Tables, “Z” represents the total amount of components excluding (i.e., not containing) curing accelerator, inorganic filler and solvent in the resin composition of each Example or Comparative Example. For instance, “Z*1.0” represents that the amount of inorganic filler is 1.0 time of “Z”. For instance, in Example E1, “Z*1.0” represents that the amount of the inorganic filler is 230 parts by weight (230 parts by weight multiplied by 1.0).

The amount of solvent is shown as “PA” in the Tables to indicate a “proper amount” to represent an amount of solvents used to achieve a desirable solid content of the whole resin composition. For a resin composition comprising butanone and toluene as solvents, “PA” represents the total amount of the two solvents used to achieve a desirable solid content of the whole resin composition, such as a solid content of 70 wt %, but the present disclosure is not limited thereto.

Components and testing results of the resin composition of Examples and Comparative Examples are shown in Table 1 to Table 5 (in parts by weight):

TABLE 1
The components (in parts by weight) and the property testing results of the resin composition of Examples E1-E7

| Components | | E1 | E2 | E3 | E4 | E5 | E6 | E7 |
|---|---|---|---|---|---|---|---|---|
| Synthesis Example 1 | Compound A | 100 | — | — | — | — | — | — |
| Synthesis Example 2 | Compound B | — | 100 | — | 120 | 80 | — | — |
| Synthesis Example 3 | Compound C | — | — | 100 | — | — | — | — |
| Synthesis Example 4 | Compound D | — | — | — | — | — | 100 | — |
| Synthesis Example 5 | Compound E | — | — | — | — | — | — | 100 |
| Synthesis Example 6 | Compound F | — | — | — | — | — | — | — |
| Vinyl group- | OPE-2st 2200 | 100 | 100 | 100 | 100 | 100 | 100 | 100 |
| containing | SA9000 | — | — | — | — | — | — | — |
| polyphenylene ether | | | | | | | | |
| resin | | | | | | | | |
| Vinyl group- | TAIC | 30 | 30 | 30 | 30 | 30 | 30 | 30 |
| containing | DVB | — | — | — | — | — | — | — |
| crosslinking agent | | | | | | | | |
| Polyolefin resin | B-1000 | — | — | — | — | — | — | — |
| | SBS-C | — | — | — | — | — | — | — |
| | D1118 | — | — | — | — | — | — | — |
| | H1051 | — | — | — | — | — | — | — |
| Flame retardant | PX-200 | — | — | — | — | — | — | — |
| | S-2 | — | — | — | — | — | — | — |
| Inorganic filler | SC-2500SMJ | Z*1.0 | Z*1.0 | Z*1.0 | Z*1.0 | Z*1.0 | Z*1.0 | Z*1.0 |
| Curing accelerator | 25B | 0.3 | 0.3 | 0.3 | 0.3 | 0.3 | 0.3 | 0.3 |
| Solvent | Butanone | PA | PA | PA | PA | PA | PA | PA |
| | Toluene | PA | PA | PA | PA | PA | PA | PA |
| Property test | Unit | E1 | E2 | E3 | E4 | E5 | E6 | E7 |
| Tg | ° C. | 213 | 200 | 193 | 197 | 206 | 215 | 229 |
| Dielectric constant | / | 3.20 | 3.10 | 3.00 | 3.10 | 3.10 | 3.20 | 3.26 |
| Dissipation factor | / | 0.0025 | 0.0022 | 0.0020 | 0.0020 | 0.0024 | 0.0020 | 0.0026 |
| PCT 5 h | by visual | ◯◯◯ | ◯◯◯ | ◯◯◯ | ◯◯◯ | ◯◯◯ | ◯◯◯ | ◯◯◯ |
| | inspection | | | | | | | |
| | with naked | | | | | | | |
| | eyes | | | | | | | |
| Flame retardancy | UL-94 | V-0 | V-0 | V-1 | V-0 | V-1 | V-0 | V-0 |
| Inner resin flow | mm | 6.0 | 8.0 | 10.0 | 10.0 | 6.0 | 6.5 | 6.0 |
| Drop ball test | cm | 35.0 | 45.0 | 50.0 | 45.0 | 35.0 | 40.0 | 35.0 |

TABLE 2
The components (in parts by weight) and the property testing results of the resin composition of Examples E8-E14

| Components | | E8 | E9 | E10 | E11 | E12 | E13 | E14 |
|---|---|---|---|---|---|---|---|---|
| Synthesis Example 1 | Compound A | — | — | — | — | — | — | — |
| Synthesis Example 2 | Compound B | — | 100 | 100 | 100 | 100 | 100 | 100 |
| Synthesis Example 3 | Compound C | — | — | — | — | — | — | — |
| Synthesis Example 4 | Compound D | — | — | — | — | — | — | — |
| Synthesis Example 5 | Compound E | — | — | — | — | — | — | — |
| Synthesis Example 6 | Compound F | 100 | — | — | — | — | — | — |
| Vinyl group- | OPE-2st 2200 | 100 | — | 50 | 100 | 100 | 100 | 100 |
| containing | SA9000 | — | 100 | 50 | — | — | — | — |
| polyphenylene ether | | | | | | | | |
| resin | | | | | | | | |
| Vinyl group- | TAIC | 30 | 30 | 15 | 15 | 45 | 30 | 30 |
| containing | DVB | — | — | 15 | — | — | — | — |
| crosslinking agent | | | | | | | | |
| Polyolefin resin | B-1000 | — | — | — | — | — | 20 | 30 |
| | SBS-C | — | — | — | — | — | — | — |
| | D1118 | — | — | — | — | — | — | — |
| | H1051 | — | — | — | — | — | — | — |
| Flame retardant | PX-200 | — | — | — | — | — | — | — |
| | S-2 | — | — | — | — | — | — | — |
| Inorganic filler | SC-2500SMJ | Z*1.0 | Z*1.0 | Z*1.0 | Z*1.0 | Z*1.0 | Z*1.0 | Z*1.0 |
| Curing accelerator | 25B | 0.3 | 0.3 | 0.3 | 0.3 | 0.3 | 0.3 | 0.3 |
| Solvent | Butanone | PA | PA | PA | PA | PA | PA | PA |
| | Toluene | PA | PA | PA | PA | PA | PA | PA |
| Property test | Unit | E8 | E9 | E10 | E11 | E12 | E13 | E14 |
| Tg | ° C. | 232 | 210 | 220 | 189 | 227 | 200 | 192 |
| Dielectric constant | / | 3.30 | 3.16 | 3.20 | 3.10 | 3.26 | 3.00 | 2.85 |
| Dissipation factor | / | 0.0030 | 0.0025 | 0.0023 | 0.0020 | 0.0027 | 0.0018 | 0.0016 |
| PCT 5 h | by visual | ◯◯◯ | ◯◯◯ | ◯◯◯ | ◯◯◯ | ◯◯◯ | ◯◯◯ | ◯◯◯ |
| | inspection | | | | | | | |
| | with naked | | | | | | | |
| | eyes | | | | | | | |
| Flame retardancy | UL-94 | V-0 | V-0 | V-0 | V-1 | V-0 | V-0 | V-1 |
| Inner resin flow | mm | 5.0 | 8.0 | 6.0 | 5.0 | 9.0 | 5.0 | 6.0 |
| Drop ball test | cm | 35.0 | 40.0 | 40.0 | 55.0 | 40.0 | 50.0 | 60.0 |

TABLE 3
The components (in parts by weight) and the property testing results of the resin composition of Examples E15-E21

| Components | | E15 | E16 | E17 | E18 | E19 | E20 | E21 |
|---|---|---|---|---|---|---|---|---|
| Synthesis Example 1 | Compound A | — | 50 | — | — | — | 100 | 50 |
| Synthesis Example 2 | Compound B | 100 | 50 | 100 | 100 | 100 | — | 50 |
| Synthesis Example 3 | Compound C | — | — | — | — | — | — | — |
| Synthesis Example 4 | Compound D | — | — | — | — | — | — | — |
| Synthesis Example 5 | Compound E | — | — | — | — | — | — | — |
| Synthesis Example 6 | Compound F | — | — | — | — | — | — | — |
| Vinyl group- | OPE-2st 2200 | 100 | 30 | 100 | 100 | 100 | 100 | 40 |
| containing | SA9000 | — | 70 | — | — | — | — | 60 |
| polyphenylene ether | | | | | | | | |
| resin | | | | | | | | |
| Vinyl group- | TAIC | 30 | 20 | 30 | 30 | 30 | 30 | 15 |
| containing | DVB | — | 10 | — | — | — | — | 15 |
| crosslinking agent | | | | | | | | |
| Polyolefin resin | B-1000 | 60 | 30 | — | — | — | 40 | 20 |
| | SBS-C | — | 5 | 50 | — | — | — | 15 |
| | D1118 | — | — | — | 50 | — | — | — |
| | H1051 | — | 5 | — | — | 50 | — | 15 |
| Flame retardant | PX-200 | — | — | — | — | — | 5 | 5 |
| | S-2 | — | — | — | — | — | — | 5 |
| Inorganic filler | SC-2500SMJ | Z*1.0 | Z*1.0 | Z*1.0 | Z*1.0 | Z*1.0 | Z*0.5 | Z*1.5 |
| Curing accelerator | 25B | 0.30 | 0.30 | 0.30 | 0.30 | 0.30 | 0.15 | 0.60 |
| Solvent | Butanone | PA | PA | PA | PA | PA | PA | PA |
| | Toluene | PA | PA | PA | PA | PA | PA | PA |
| Property test | Unit | E15 | E16 | E17 | E18 | E19 | E20 | E21 |
| Tg | ° C. | 185 | 205 | 213 | 226 | 215 | 201 | 223 |
| Dielectric constant | / | 2.70 | 2.85 | 2.75 | 2.70 | 2.80 | 2.75 | 2.85 |
| Dissipation factor | / | 0.0013 | 0.0015 | 0.0015 | 0.0013 | 0.0014 | 0.0014 | 0.0017 |
| PCT 5 h | by visual | ◯◯◯ | ◯◯◯ | ◯◯◯ | ◯◯◯ | ◯◯◯ | ◯◯◯ | ◯◯◯ |
| | inspection | | | | | | | |
| | with naked | | | | | | | |
| | eyes | | | | | | | |
| Flame retardancy | UL-94 | V-1 | V-1 | V-1 | V-1 | V-1 | V-1 | V-0 |
| Inner resin flow | mm | 9.5 | 5.5 | 6.0 | 6.0 | 6.0 | 7.5 | 5.5 |
| Drop ball test | cm | 70.0 | 65.0 | 60.0 | 65.0 | 65.0 | 60.0 | 70.0 |

TABLE 4
The components (in parts by weight) and the property testing
results of the resin composition of Comparative Example C1-C7

| Components | | C1 | C2 | C3 | C4 | C5 | C6 | C7 |
|---|---|---|---|---|---|---|---|---|
| Synthesis Example 2 | Compound B | 130 | 70 | — | — | — | — | — |
| Hexakis(4- | | — | — | 100 | — | 65 | — | — |
| vinylphenoxy)cyclotriphosphazene | | | | | | | | |
| Phenyldimethylsilane | | — | — | — | 100 | 35 | — | — |
| Comparitive | Compound 1 | — | — | — | — | — | 100 | — |
| Synthesis Example 1 | | | | | | | | |
| Comparitive | Compound 2 | — | — | — | — | — | — | 100 |
| Synthesis Example 2 | | | | | | | | |
| Comparitive | Compound 3 | — | — | — | — | — | — | — |
| Synthesis Example 3 | | | | | | | | |
| Phenyltrivinylsilane | | — | — | — | — | — | — | — |
| Comparitive | Compound 4 | — | — | — | — | — | — | — |
| Synthesis Example4 | | | | | | | | |
| Comparitive | Compound 5 | — | — | — | — | — | — | — |
| Synthesis Example5 | | | | | | | | |
| Vinyl group- | OPE-2st 2200 | 100 | 100 | 100 | 100 | 100 | 100 | 100 |
| containing | | | | | | | | |
| polyphenylene ether | | | | | | | | |
| resin | | | | | | | | |
| Vinyl group- | TAIC | 30 | 30 | 30 | 30 | 30 | 30 | 30 |
| containing | | | | | | | | |
| crosslinking agent | | | | | | | | |
| Inorganic filler | SC-2500SMJ | Z*1.0 | Z*1.0 | Z*1.0 | Z*1.0 | Z*1.0 | Z*1.0 | Z*1.0 |
| Curing accelerator | 25B | 0.3 | 0.3 | 0.3 | 0.3 | 0.3 | 0.3 | 0.3 |
| Solvent | Butanone | PA | PA | PA | PA | PA | PA | PA |
| | Toluene | PA | PA | PA | PA | PA | PA | PA |
| Property test | Unit | C1 | C2 | C3 | C4 | C5 | C6 | C7 |
| Tg | ° C. | 176 | 220 | 240 | 176 | 230 | 170 | 230 |
| Dielectric constant | / | 3.05 | 3.15 | 3.40 | 3.05 | 3.20 | 3.45 | 3.41 |
| Dissipation factor | / | 0.0017 | 0.0030 | 0.0037 | 0.0020 | 0.0035 | 0.0030 | 0.0038 |
| PCT 5 h | by visual | XXX | ◯◯◯ | XXX | XXX | XXX | XXX | ◯◯◯ |
| | inspection with | | | | | | | |
| | naked eyes | | | | | | | |
| Flame retardancy | UL-94 | V-0 | V-2 | V-0 | V-2 | V-2 | V-0 | V-2 |
| Inner resin flow | mm | 11.0 | 4.0 | 1.0 | 1.0 | 1.0 | 11.0 | 8.0 |
| Drop ball test | cm | 50.0 | 28.0 | 20.0 | 60.0 | 35.0 | 47.0 | 30.0 |

TABLE 5
The components (in parts by weight) and the property testing results
of the resin composition of Comparative Example C8-C13

| Components | | C8 | C9 | C10 | C11 | C12 | C13 |
|---|---|---|---|---|---|---|---|
| Synthesis Example2 | Compound B | — | — | — | — | 100 | 100 |
| Hexakis(4- | | — | — | — | — | — | — |
| vinylphenoxy)cyclotriphosphazene | | | | | | | |
| phenyldimethylsilane | | — | — | — | — | — | — |
| Comparitive Synthesis | Compound 1 | — | — | — | — | — | — |
| Example 1 | | | | | | | |
| Comparitive Synthesis | Compound 2 | — | — | — | — | — | — |
| Example 2 | | | | | | | |
| Comparitive Synthesis | Compound 3 | 100 | — | — | — | — | — |
| Example 3 | | | | | | | |
| Phenyltrivinylsilane | | — | 100 | — | — | — | — |
| Comparitive Synthesis | Compound 4 | — | — | 100 | — | — | — |
| Example 4 | | | | | | | |
| Comparitive Synthesis | Compound 5 | — | — | — | 100 | — | — |
| Example 5 | | | | | | | |
| Vinyl group-containing | OPE-2st 2200 | 100 | 100 | 100 | 100 | 100 | 100 |
| polyphenylene ether | | | | | | | |
| resin | | | | | | | |
| Vinyl group-containing | TAIC | 30 | 30 | 30 | 30 | 5 | 55 |
| crosslinking agent | | | | | | | |
| Inorganic filler | SC-2500SMJ | Z*1.0 | Z*1.0 | Z*1.0 | Z*1.0 | Z*1.0 | Z*1.0 |
| Curing accelerator | 25B | 0.3 | 0.3 | 0.3 | 0.3 | 0.3 | 0.3 |
| Solvent | Butanone | PA | PA | PA | PA | PA | PA |
| | Toluene | PA | PA | PA | PA | PA | PA |
| Property test | Unit | C8 | C9 | C10 | C11 | C12 | C13 |
| Tg | ° C. | 180 | 225 | 240 | 175 | 180 | 237 |
| Dielectric constant | / | 3.35 | 3.35 | 3.40 | 3.40 | 3.05 | 3.40 |
| Dissipation factor | / | 0.0036 | 0.0022 | 0.0041 | 0.0019 | 0.0017 | 0.0035 |
| PCT 5 h | by visual | XXX | XXX | ◯◯◯ | XXX | XXX | ◯◯◯ |
| | inspection | | | | | | |
| | with naked | | | | | | |
| | eyes | | | | | | |
| Flame retardancy | UL-94 | V-0 | V-2 | V-2 | V-2 | V-1 | V-0 |
| Inner resin flow | mm | 10.0 | 2.0 | 3.0 | 12.0 | 4.0 | 9.5 |
| Drop ball test | cm | 30.0 | 29.0 | 38.0 | 40.0 | 55.0 | 27.0 |

Resin compositions from Table 1 to Table 5 are used to form varnishes and various samples (specimens) as described below and tested under conditions specified below so as to obtain the testing results.

### Varnish

Components of the resin composition for each Example (abbreviated as E, such as E1 to E21) or Comparative Example (abbreviated as C, such as C1 to C13) are added to a stirrer according to the amounts listed in Table 1 to Table 5 and stirred and well-mixed to form a resin varnish.

For instance, in Example E1, 100 parts by weight of a compound A, 100 parts by weight of a vinyl group-containing polyphenylene ether resin (SA9000) and 30 parts by weight of a vinyl group-containing crosslinking agent (TAIC) are added to a stirrer containing a proper amount of toluene and a proper amount of butanone (“proper amount” in Table 1 to Table 5 represents the amount of the solvent used to achieve a desirable solid content of the whole resin composition, such as a varnish having a solid content of 70 wt %), and the solution is mixed and stirred to fully dissolve the solid components to form a homogeneous liquid state. Then “Z*1.0” parts by weight of spherical silica SC-2500SMJ (i.e., 230 parts by weight) are added and well dispersed, followed by adding 0.3 part by weight of a curing accelerator (25B, pre-dissolved by a proper amount of solvent) and stirred for 1 hour to obtain the varnish of resin composition E1.

In addition, according to the components and amounts listed in Table 1 to Table 5 mentioned above, varnishes of Examples E2-E21 and Comparative Examples C1-C13 are prepared by the preparation method of the varnish of Example E1.

### Prepreg 1 (Using 2116 E-Glass Fiber Fabric)

Resin compositions from different Examples (E1 to E21) and Comparative Examples (C1 to C13) listed in Table 1 to Table 5 are respectively added to a stirred tank, well mixed and fully dissolved into varnishes and then loaded to an impregnation tank. A glass fiber fabric (e.g., 2116 E-glass fiber fabric) is immersed into the impregnation tank to adhere the resin composition onto the glass fiber fabric, followed by heated at 120° C. to 150° C. to the semi-cured state (B-Stage) to obtain the prepreg 1 (resin content of about 52%).

### Prepreg 2 (Using 1080 E-Glass Fiber Fabric)

Resin compositions from different Examples (E1 to E21) and Comparative Examples (C1 to C13) listed in Table 1 to Table 5 are respectively added to a stirred tank, well mixed and fully dissolved into varnishes and then loaded to an impregnation tank. A glass fiber fabric (e.g., 1080 E-glass fiber fabric) is immersed into the impregnation tank to adhere the resin composition onto the glass fiber fabric, followed by heated at 120° C. to 150° C. to the semi-cured state (B-Stage) to obtain the prepreg 2 (resin content of about 70%).

### Copper-Clad Laminate 1 (Formed by Laminating Eight Prepregs 1)

Two reverse treat foils (RTF copper foils) with a thickness of 18 m and eight prepregs 1 made from each resin composition (using 2116 E-glass fiber fabrics) are prepared, respectively. Each prepreg has a resin content of about 52%. A copper foil, eight prepregs 1 and a copper foil are stacked in such order, followed by lamination under vacuum at 210° C. for 2 hours to form each copper-clad laminate 1. The eight prepregs stacked with each other are cured (C-stage) and formed into an insulation layer between the two copper foils, and a resin content of the insulation layer is about 52%.

### Copper-Clad Laminate 2 (Formed by Laminating Two Prepregs 2)

Two reverse treat foils (RTF copper foils) with a thickness of 18 m and two prepregs 2 made from each resin composition (using 1080 E-glass fiber fabrics) are prepared, respectively. Each prepreg has a resin content of about 70%. A copper foil, two prepregs and a copper foil are stacked in such order, followed by lamination under vacuum at 210° C. for 2 hours to form each copper-clad laminate 2. The two prepregs stacked with each other are cured (C-stage) and formed into an insulation layer between the two copper foils, and a resin content of the insulation layer is about 70%.

### Copper-Clad Laminate 3 (Formed by Laminating Six Prepregs 1)

Two reverse treat foils (RTF copper foils) with a thickness of 18 m and six prepregs 1 made from each resin composition (using 2116 E-glass fiber fabrics) are prepared, respectively. Each prepreg has a resin content of about 52%. A copper foil, six prepregs 1 and a copper foil are stacked in such order, followed by lamination under vacuum at 210° C. for 2 hours to form each copper-clad laminate 3. The six prepregs stacked with each other are cured (C-stage) and formed into an insulation layer between the two copper foils, and a resin content of the insulation layer is about 52%.

### Copper-Free Laminate 1 (Formed by Laminating Eight Prepregs 1)

Each copper-clad laminate 1 is etched to remove the two copper foils to obtain a copper-free laminate 1 which is formed by laminating eight prepregs 1 and has a resin content of about 52%.

### Copper-Free Laminate 2 (Formed by Laminating Two Prepregs 2)

Each copper-clad laminate 2 is etched to remove the two copper foils to obtain a copper-free laminate 2 which is formed by laminating two prepregs 2 and has a resin content of about 70%.

### Copper-Free Laminate 3 (Formed by Laminating Six Prepregs 1)

Each copper-clad laminate 3 is etched to remove the two copper foils to obtain a copper-free laminate 3 which is formed by laminating six prepregs 1 and has a resin content of about 52%.

The testing method and the property analysis are described below.

### 1. Glass Transition Temperature (Tg)

In the measurement of glass transition temperature, the copper-free laminates 1 are selected as samples. A dynamic mechanical analyzer (DMA) is used by reference to IPC-TM-650 2.4.24.4 to measure the glass transition temperature of each sample (in ° C., recorded as DMA-Tg). Temperature interval during the measurement was set at 50 to 400° C. with a temperature increasing rate of 2° C./minute. The higher the glass transition temperature is better, and a difference in the glass transition temperature of different samples greater than or equal to 5° C. represents a significant difference (i.e., significant technical difficulty is present) in glass transition temperature of different samples.

For instance, the glass transition temperatures of the articles made from the resin composition of the present disclosure measured by reference to IPC-TM-6502.4.24.4 are greater than or equal to 185° C., such as between 185° C. and 232° C., such as between 185° C. and 226° C., and such as between 192° C. and 226° C.

### 2. Dielectric Constant (Dk) and Dissipation Factor (Df)

In the measurement of dielectric constant and dissipation factor, the copper-free laminate 2 are selected as samples. A microwave dielectrometer (available from AET Corp.) is used by reference to JIS C2565 to measure each sample at 10 GHz. Lower dielectric constant or dissipation factor represents better dielectric properties of the sample. At a frequency of 10 GHz, for a Dk value of less than or equal to 3.60 and a Df value of less than or equal to 0.004, a difference in Dk of greater than or equal to 0.05 represents a significant difference (i.e., significant technical difficulty) in dielectric constant in different laminates, and difference in Df of less than 0.0001 represents no significant difference in dissipation factor in different laminates, and a difference in Df of greater than or equal to 0.0001 represents a significant difference (i.e., significant technical difficulty is present) in dissipation factor of different laminates.

For instance, the dielectric constants of articles made from the resin composition of the present disclosure measured by reference to JIS C2565 at 10 GHz are less than or equal to 3.30, such as between 2.70 and 3.30, such as between 2.70 and 3.0, such as between 2.70 and 2.85; the dissipation factors of articles made from the resin composition of the present disclosure measured by reference to JIS C2565 at 10 GHz are less than or equal to 0.0030, such as between 0.0013 and 0.0030, such as between 0.0013 and 0.0018, and such as between 0.0013 and 0.0017.

3. Thermal Resistance after Moisture Absorption (PCT)

The copper-free laminates 1 are selected as samples. By reference to IPC-TM-650 2.6.16.1, the samples are subject to the pressure cooking test (PCT) for 5 hours of moisture absorption (at a temperature of 121° C. and a relative humidity of 100%), immersed into a solder pot with a constant temperature of 288° C. for 20 seconds, and inspected for the occurrence of delamination by reference to IPC-TM-650 2.4.23. For instance, the occurrence of an interlayer peeling between insulating layers can be referred to as a delamination. The interlayer delamination may cause blistering and separation between any layers of the laminate (which can be inspected by eyes). For instance, there is no delamination after the articles made from the resin composition of the present disclosure are subjected to heat resistance test after 5 hours of moisture absorption by reference to IPC-TM-650 2.6.16.1 and IPC-TM-650 2.4.23. (The requirement of the specification of the laminate or the printed circuit board in the industry is that there is no delamination after the heat resistance test after 1 hour of moisture absorption).

### 4. Flame Retardancy

In the measurement of flame retardancy, the copper-free laminates 1 are selected as samples. The flame retardancy is measured by reference to UL 94 rating, and the results are represented by V-0, V-1, or V-2, wherein the flame retardancy of V-0 is better than the flame retardancy of V-1, and the flame retardancy of V-1 is better than the flame retardancy of V-2.

For instance, the articles made from the resin composition of the present disclosure have the flame retardancy measured by reference to UL 94 rating of V-0 or V-1.

### 5. Inner Resin Flow

First, an EM-827 copper-clad laminate is selected as a copper-containing core (available from Elite Electronic Material (Zhongshan) Co., Ltd., using 7628 E-glass fiber fabric and 1-ounce HTE copper foil), which has a thickness of 28 mil. Then, the outmost copper foil of the copper-containing core is subjected to a conventional brown oxidation process to obtain a brown oxide-treated core.

A prepreg 2 prepared from each Example (E1 to E21) and each Comparative Example (C1 to C13) and a brown oxide-treated core (with a thickness of 28 mil, a length of 18 inches, and a width of 16 inches) are prepared, respectively, wherein the center of the prepreg 2 is a 4 inches*4 inches rhombus opening formed by using a conventional punching machine.

A 0.5-ounce HTE copper foil (in reverse position, i.e., the glossy surface (shiny side) of the copper foil is in contact with the prepreg 2), a prepreg 2 and a brown oxide-treated core are stacked in such order, followed by lamination and curing for 2 hours under vacuum at high temperature (200° C.) and high pressure (360 psi) to obtain a copper-containing multi-layer board. The outmost reverse copper foil of the copper-containing multi-layer board is removed to obtain a sample for an inner resin flow test. Each side of the 4 inches*4 inches rhombus shape of the sample for the inner resin flow test is divided into four equal sections by three dividing points, and the resin flow (i.e., vertical distance of resin flow) of each of the twelve points is measured to obtain the average of resin flow at the twelve points, so as to obtain the inner resin flow (as an average, in mm) of the sample. In the present technical field, higher inner resin flow represents better flowability of the prepreg, and a difference in inner resin flow of greater than or equal to 1 mm represents a significant difference (i.e., significant technical difficulty is present). Generally, the inner resin flow is preferably between 5.0 mm and 20.0 mm. An inner resin flow of less than 5.0 mm represents insufficiency of the inner resin flow. If the prepreg is then used for building-up layers, it may fail to effectively fill the holes by resin flow, which may cause resin insufficiency or delamination in a circuit board. The articles made from the resin composition of the present disclosure have an inner resin flow greater than or equal to 5.0 mm, for instance, such as between 5.0 mm and 10.0 mm, such as between 5.0 mm and 9.5 mm, and such as between 5.5 mm and 7.5 mm.

### 6. Drop Ball Test

The copper-free laminates 3 are selected as samples. A 20*20 mm grid is made on a 60*160 mm copper-free laminate 3, and then the copper-free laminate 3 is placed on the support stage of a Dupont impact tester. A hammer weighing 100 grams is freely dropped from a certain height to impact an arc-shaped crashing head with a radius of 7.9 mm. After the arc-shaped crashing head impacts the sample, the degree of damage to the sample is inspected. The same sample is tested 3 times at each height. If there is no damage on the surface of the sample, the height of the hammer head will increase by raising it. The damage refers to problems such as cracks, crackles, whitening, white spots or smash marks on the surface of the copper-free laminate 3, but the present disclosure is not limited thereto. The samples are tested starting from a height of 1 cm, and the test is repeated until the number of surface damages on the sample exceeds 2, that is, the sample is considered to be damaged at this height, and the current height is recorded. For instance, when the number of white spots on the surface of the sample exceeds 2, it is determined that the sample is damaged at this height, and the current height is recorded. In the present technical field, the higher the measured height represents the better the impact toughness of the sample. The difference in the drop-ball height greater than or equal to 5 cm represents a significant difference (i.e., significant technical difficulty is present). Generally, when the drop-ball height is greater than 35 cm, for instance, between 35 cm and 70 cm, it proves that the sample is qualified. It is better when the drop-ball height is greater than 50 cm, for instance, between 50 cm and 70 cm. It is much better when the drop-ball height is greater than 60 cm, for instance, between 60 cm and 70 cm. When the sample passes the ball drop test, it means that the sample has good toughness and impact resistance, which facilitates the subsequent PCB processing process.

The following observations can be made from Table 1 to Table 5.

By comparing Examples E1-E3, E6-E8 and Comparative Examples C6, it can be confirmed that compared to compound 1, the compound of Formula (I) of the present disclosure can achieve at least one of the effects of a glass transition temperature greater than or equal to 185° C., a dissipation factor less than or equal to 3.30 or passing PCT heat resistance test.

By comparing Examples E1-E3, E6-E8 and Comparative Examples C7-C11, it can be confirmed that compared to other phosphorus-containing compounds, the compound of Formula (I) of the present disclosure can achieve at least one of the effects of increasing glass transition temperature, reducing dielectric constant, reducing dissipation factor, passing PCT heat resistance test, increasing flame retardancy, increasing inner resin flow and increasing drop-ball height at the same time.

By comparing Examples E2 and Comparative Examples C₃-C₅, it can be confirmed that compared to a case adding hexakis(4-vinylphenoxy)cyclotriphosphazene alone, adding phenyldimethylsilane alone or adding (non pre-polymerized) hexakis(4-vinylphenoxy)cyclotriphosphazene and phenyldimethylsilane, the compound of Formula (I) of the present disclosure can achieve at least one of the effects of increasing glass transition temperature, reducing dielectric constant, reducing dissipation factor, passing PCT heat resistance test, increasing flame retardancy, increasing inner resin flow and increasing drop-ball height at the same time.

By comparing Examples E2, E4-E5 and Comparative Examples C1-C2 or by comparing Examples E1-E8 and Comparative Examples C1-C2, it can be confirmed that compared to a case using the amount out of the range from 80 parts by weight to 120 parts by weight of the compound of Formula (I) of the present disclosure, the compound of Formula (I) of the present disclosure, which uses the amount within such range, can achieve at least one of the effects of increasing glass transition temperature, passing PCT heat resistance test, increasing flame retardancy, increasing inner resin flow and increasing drop-ball height at the same time.

By comparing Examples E1-E21 and Comparative Examples C1-C13, it can be confirmed that the article made from the compound of Formula (I) of the present disclosure can achieve at least one of the effects of a glass transition temperature greater than or equal to 185° C., a dielectric constant less than or equal to 3.30, a dissipation factor less than or equal to 0.0030, an inner resin flow greater than or equal to 5.0 mm and a drop-ball height greater than or equal to 35 cm at the same time. On the contrary, Comparative Examples C1-C7 which do not use the technical means of the present disclosure fail to achieve the effects above at the same time.

What is claimed is:

1. A compound, having a structure represented by Formula (I): 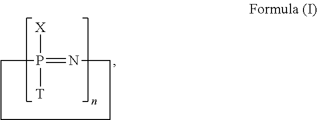
wherein n is an integer of 3 to 6, each of X and T is independently represented by Formula (1) or Formula (2), and at least one of X and T is represented by Formula (2), wherein m is an integer of 0 to 4, Rₐ is a hydrogen atom or an alkyl group with 1 to 4 carbon atoms, each of R_{b}, R_{c}, and R_{d} is independently an alkyl group with 1 to 4 carbon atoms, a phenyl group or a naphthyl group;

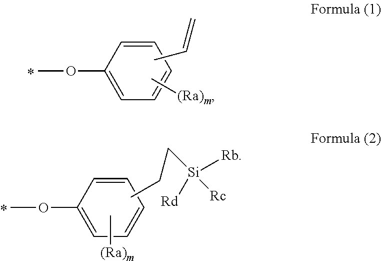

2. The compound of claim 1, wherein structures of X and T in Formula (I) are represented by Formula (3) or Formula (4):

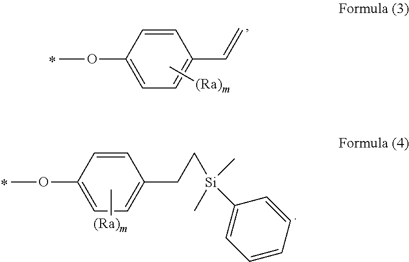

3. The compound of claim 2, wherein the structures of X and T in Formula (I) comprise at least two Formula (3), and the structures of X and T in Formula (I) comprise at least two Formula (4).

4. The compound of claim 1, wherein Formula (I) has a structure represented by any one of Formula (II), Formula (III), Formula (IV), Formula (V), Formula (VI) or Formula (VII):

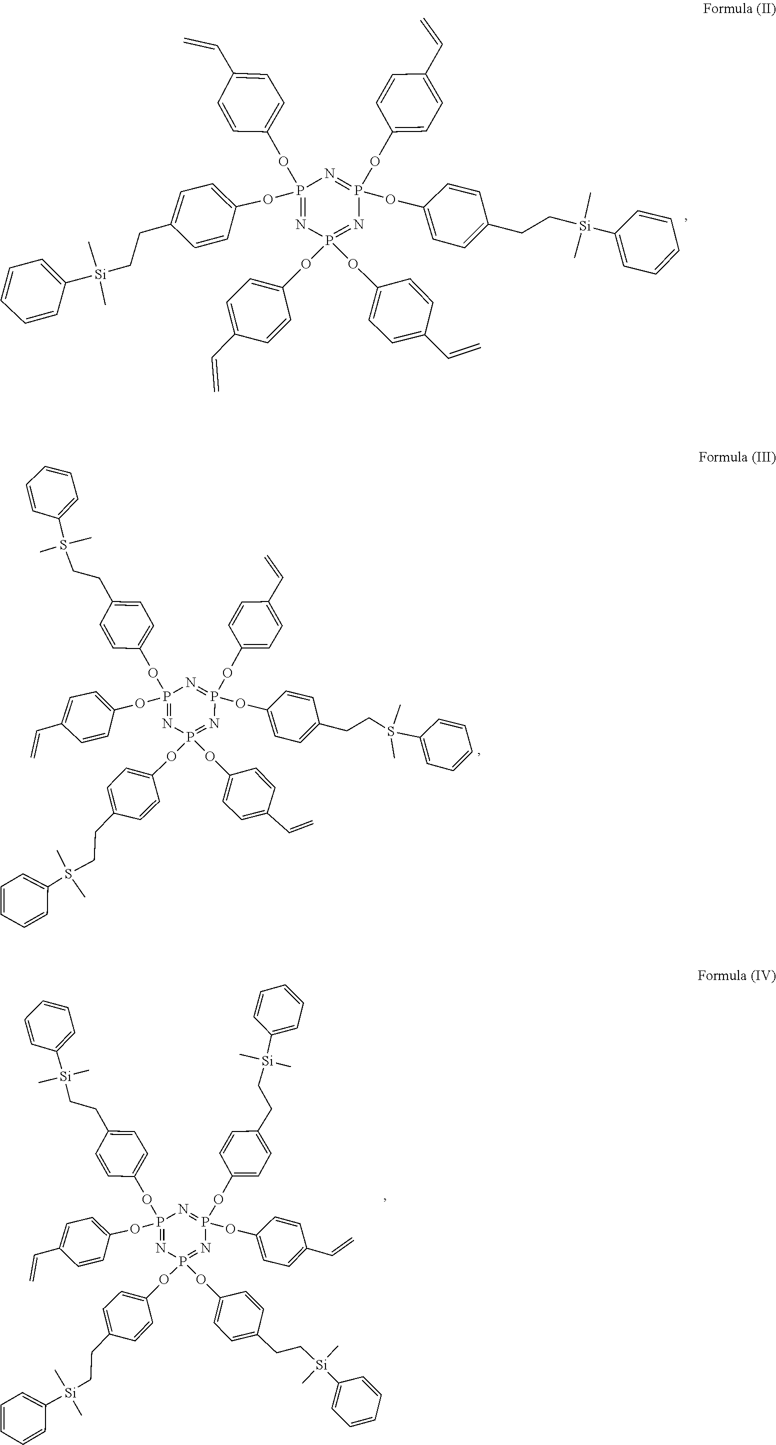 [SMILES: C=Cc1ccc(OP2(Oc3ccc(C=C)cc3)=NP(Oc3ccc(C=C)cc3)(Oc3ccc(CC[Si](C)(C)c4ccccc4)cc3)=NP(Oc3ccc(C=C)cc3)(Oc3ccc(CC[Si](C)(C)c4ccccc4)cc3)=N2)cc1 ; C=Cc1ccc(OP2(Oc3ccc(CCS(C)(C)c4ccccc4)cc3)=NP(Oc3ccc(C=C)cc3)(Oc3ccc(CCS(C)(C)c4ccccc4)cc3)=NP(Oc3ccc(C=C)cc3)(Oc3ccc(CCS(C)(C)c4ccccc4)cc3)=N2)cc1 ; C=Cc1ccc(OP2(Oc3ccc(CC[Si](C)(C)c4ccccc4)cc3)=NP(Oc3ccc(C=C)cc3)(Oc3ccc(CC[Si](C)(C)c4ccccc4)cc3)=NP(Oc3ccc(CC[Si](C)(C)c4ccccc4)cc3)(Oc3ccc(CC[Si](C)(C)c4ccccc4)cc3)=N2)cc1]

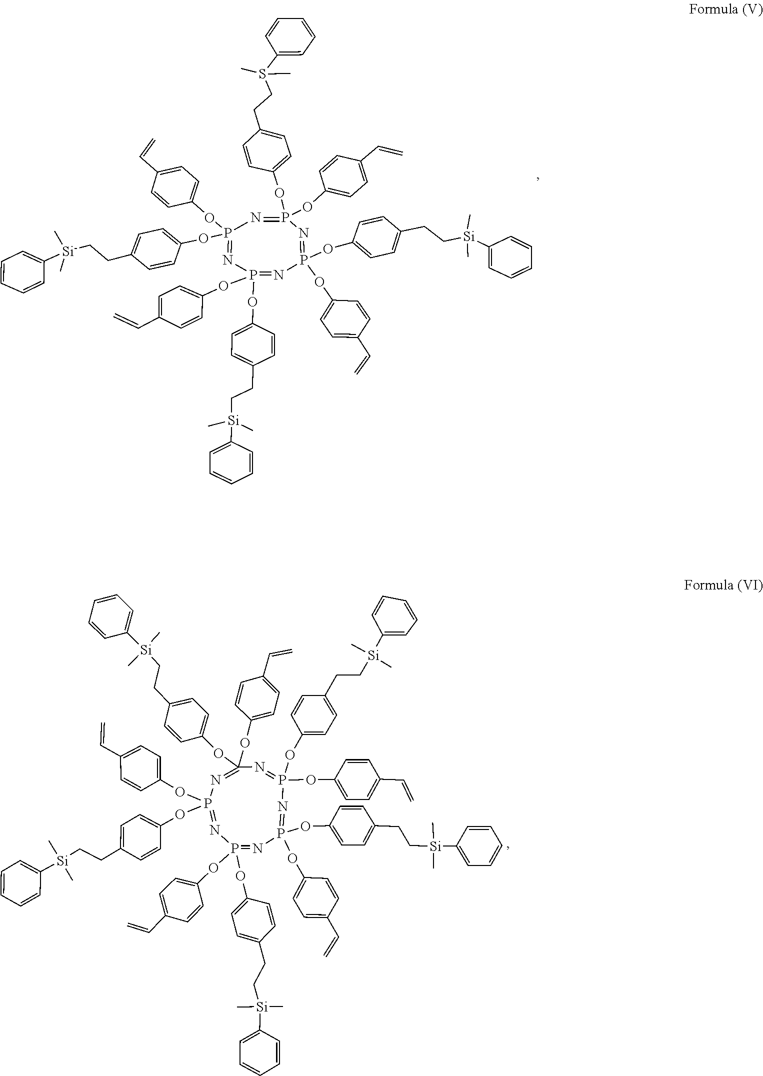

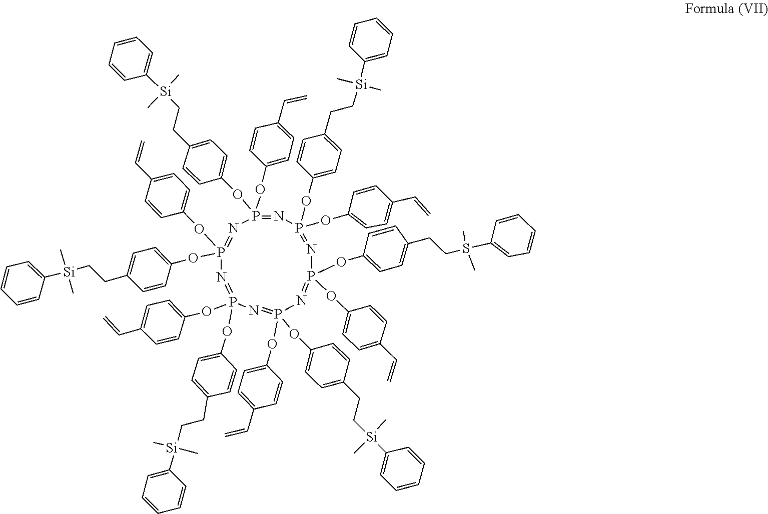 [SMILES: C=Cc1ccc(OP2(Oc3ccc(CC[Si](C)(C)c4ccccc4)cc3)=NP(Oc3ccc(C=C)cc3)(Oc3ccc(CC[Si](C)(C)c4ccccc4)cc3)=NP(Oc3ccc(C=C)cc3)(Oc3ccc(CC[Si](C)(C)c4ccccc4)cc3)=NP(Oc3ccc(C=C)cc3)(Oc3ccc(CCS(C)(C)c4ccccc4)cc3)=NP(Oc3ccc(C=C)cc3)(Oc3ccc(CC[Si](C)(C)c4ccccc4)cc3)=NP(Oc3ccc(C=C)cc3)(Oc3ccc(CC[Si](C)(C)c4ccccc4)cc3)=N2)cc1]

5. A manufacturing method of the compound of claim 1, comprising: a step of performing a hydrosilylation between a vinylphenoxy cyclophosphazene and a Si—H bond-containing silane compound at a temperature between 5° C. and 100° C. to obtain the structure represented by Formula (I).

6. The manufacturing method of claim 5, a molar ratio of the vinylphenoxy cyclophosphazene to the Si—H bond-containing silane compound is between 1:1 and 1:2n.

7. The manufacturing method of claim 5, wherein the vinylphenoxy cyclophosphazene has a structure represented by Formula (A), wherein n is an integer of 3 to 6, m is an integer of 0 to 4, and Ra is a hydrogen atom or an alkyl group with 1 to 4 carbon atoms;

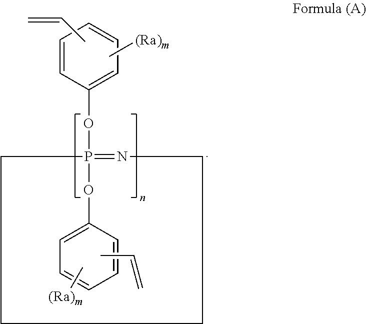

8. The manufacturing method of claim 5, wherein the vinylphenoxy cyclophosphazene is a hexakis(vinylphenoxy)cyclotriphosphazene, an octakis(vinylphenoxy)cyclotetraphosphazene, a decakis(vinylphenoxy)cyclopentaphosphazene or a dodecakis(vinylphenoxy)cyclohexaphosphazene.

9. The manufacturing method of claim 5, wherein the vinylphenoxy cyclophosphazene is a vinylphenoxy cyclophosphazene where a vinyl group is located at a para position.

10. The manufacturing method of claim 5, wherein the Si—H bond-containing silane compound has a structure represented by Formula (B): 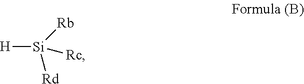
wherein, R_{b}, R_{c}, and R_{d} are independently selected from an alkyl group with 1 to 4 carbon atoms, a phenyl group or a naphthyl group.

11. The manufacturing method of claim 5, wherein the Si—H bond-containing silane compound comprises a triethylsilane, a triisopropylsilane, a triisobutylsilane, a triphenylsilane, a methyldiphenylsilane, a tert-butyldiphenylsilane, a tert-butyldimethylsilane, a dimethylphenylsilane or a dimethylnaphthylsilane.

12. A resin composition, comprising 80 parts by weight to 120 parts by weight of the formula (I) compound of claim 1, 100 parts by weight of a vinyl group-containing polyphenylene ether resin, and 15 parts by weight to 45 parts by weight of a vinyl group-containing crosslinking agent.

13. The resin composition of claim 12, wherein the vinyl group-containing polyphenylene ether resin comprises a vinylbenzyl group-terminated polyphenylene ether resin, a methacrylate group-terminated polyphenylene ether resin or an allyl group-terminated polyphenylene ether resin.

14. The resin composition of claim 13, wherein the vinylbenzyl group-terminated polyphenylene ether resin and the methacrylate group-terminated polyphenylene ether resin comprise structures represented by Formula (A-1) and Formula (A-2), respectively: 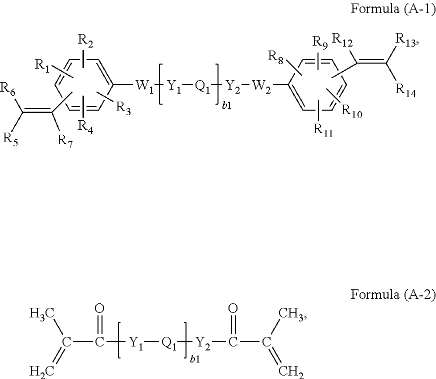
wherein, each of R₁ to R₁₄ is independently a hydrogen atom or —CH₃, and each of W₁ and W₂ is independently a C₁ to C₃ divalent aliphatic group;
b1 is an integer of 0 to 8;
Q₁ comprises a structure represented by Formula (B-1), Formula (B-2) or Formula (B-3): 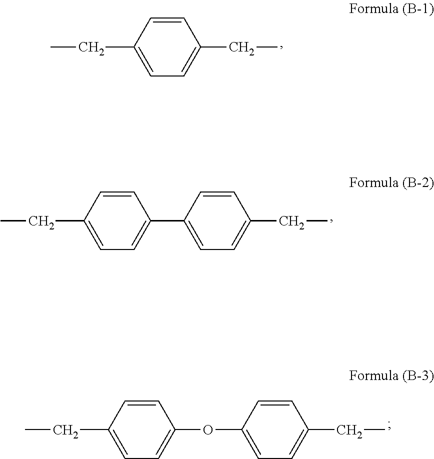
each of Y₁ and Y₂ independently comprises a structure represented by Formula (B-4): 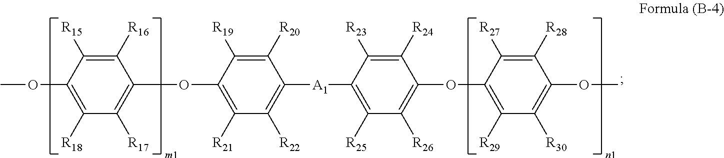
wherein, each of R₁₅ to R₃₀ is independently a hydrogen atom or —CH₃, each of m1 and n1 is independently an integer of 1 to 30, and A1 is selected from a covalent bond, —CH₂—, —CH(CH₃)—, —C(CH₃)₂—, —O—, —S—, —SO₂— and a carbonyl group.

15. The resin composition of claim 12, wherein the vinyl group-containing crosslinking agent comprises a styrene, a divinylbenzene, a divinylnaphthalene, a divinylbiphenyl, a tert-butylstyrene, a bis(vinylbenzyl)ether, a 1,2,4-trivinyl cyclohexane, a bis(vinylphenyl)ethane, a bis(vinylphenyl)hexane, a bis(vinylphenyl)dimethylene ether, a bis(vinylphenyl) dimethylene benzene, a triallyl isocyanurate, a triallyl cyanurate, a diallyl bisphenol A, a butadiene, a decadiene, an octadiene, a vinylcarbazole or an acrylate.

16. The resin composition of claim 12, further comprising 20 parts by weight to 60 parts by weight of a polyolefin resin.

17. The resin composition of claim 16, wherein the polyolefin resin comprises a polybutadiene, a polyisoprene, a styrene-butadiene copolymer, a styrene-isoprene copolymer, a styrene-butadiene-divinylbenzene terpolymer, an ethylene-divinylbenzene-styrene polymer, a styrene-divinylbenzene-ethylstyrene polymer, a styrene-butadiene-styrene copolymer, a maleic anhydride-adducted styrene-butadiene copolymer, a vinyl-polybutadiene-urethane polymer, a maleic anhydride-adducted polybutadiene, a polymethylstyrene, an ethylene propylene diene monomer, a petroleum resin, a cycloolefin copolymer, a hydrogenated polybutadiene, a hydrogenated polyisoprene, a hydrogenated styrene-butadiene-divinylbenzene terpolymer, a hydrogenated styrene-butadiene-styrene copolymer, a hydrogenated maleic anhydride-adducted styrene-butadiene copolymer, a hydrogenated styrene-butadiene copolymer or a hydrogenated styrene-isoprene copolymer.

18. The resin composition of claim 12, further comprising an amine curing agent, a flame retardant, an inorganic filler, a curing accelerator, a polymerization inhibitor, a coloring agent, a solvent, a toughening agent or a silane coupling agent.

19. An article made from the resin composition of one of claim 12, comprising a prepreg, a resin film, a laminate, a printed circuit board or a cured insulator.

20. The article of claim 19, having at least one of the following properties:
a glass transition temperature as measured by a dynamic mechanical analyzer by reference to IPC-TM-650 2.4.24.4 of greater than or equal to 185° C.;
a dielectric constant at 10 GHz as measured by reference to JIS C2565 of less than or equal to 3.30;
a dissipation factor at 10 GHz as measured by reference to IPC-TM-650 2.4.24.5 of less than or equal to 0.0030;
no delamination occurs after subjecting the article to a heat resistance after moisture absorption test for 5 hours by reference to IPC-TM-650 2.6.16.1 and IPC-TM-650 2.4.23;
a flame retardancy as measured by reference to UL 94 rating of V-1 or V-0;
an inner resin flow after lamination of greater than or equal to 5 mm; and
a drop-ball height that causes damage of greater than or equal to 35 cm.
